(19) United States
(12) Patent Application Publication
(10) Pub. No.: US 2025/0165761 A1
(43) Pub. Date: May 22, 2025

(54) SELF-LEARNING THERMODYNAMIC COMPUTING SYSTEM

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 18/742,883

(22) Filed: Jun. 13, 2024

Related U.S. Application Data
(60) Provisional application No. 63/508,718, filed on Jun. 16, 2023.

(51) Int. Cl. G06N 3/063; G06N 3/08

(52) U.S. Cl. CPC G06N 3/063; G06N 3/08

(57) ABSTRACT

A self-learning neuro thermodynamic computing device comprising thermodynamic computing chips as well as systems and methods for performing computing using a self-learning neuro thermodynamic computing device are disclosed. In some embodiments, the self-learning neuro thermodynamic computing device may automatically learn weights and biases to be used for inference generation using Langevin dynamics. In some embodiments, the self-learning neuro thermodynamic computing device comprises two or more coupled thermodynamic chips, such as a clamped thermodynamic chip configured to be clamped to input data (e.g. training data or test data), an un-clamped thermodynamic chip, and a server thermodynamic chip that coordinates between the clamped and un-clamped thermodynamic chips such that weight and bias values are maintained approximately the same between the clamped and un-clamped thermodynamic chips.

### RELATED APPLICATION

This application claims benefit of priority to U.S. Provisional Application Ser. No. 63/508,718, entitled “Self-Learning Thermodynamic Computing System,” filed Jun. 16, 2023, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1 is high-level diagram illustrating an example three-chip architecture of a self-learning neuro-thermodynamic computer included in a dilution refrigerator and coupled to a classical computing device in an environment (which may be in the dilution refrigerator or external to the dilution refrigerator), according to some embodiments.

FIG. 2A is a high-level diagram illustrating oscillators included in a substrate of one of the thermodynamic chips of a multi-chip architecture (e.g., a two-chip architecture, a three-chip architecture, etc.) and mapping of the oscillators to logical neurons of the thermodynamic chip, according to some embodiments.

FIG. 2B is an additional high-level diagram illustrating oscillators included in a substrate of the thermodynamic chip mapped to logical neurons, weights, and biases of a given self-learning neuro-thermodynamic computing system, according to some embodiments.

FIG. 3 is a high-level diagram illustrating logical relationships between neurons of the thermodynamic chip that are physically implemented via electrical or magnetic flux couplings between oscillators of the substrate of the thermodynamic chip, according to some embodiments.

FIG. 4 is a high-level diagram illustrating a pulse drive that initializes respective hyperparameters of the given system, according to some embodiments.

FIG. 5 illustrates example couplings between visible neurons, weights, and biases (e.g., synapses) of a thermodynamic chip, according to some embodiments.

FIG. 6 illustrates an example hardware implementation of a given three-chip architecture of a self-learning neuro-thermodynamic computer, according to some embodiments.

FIGS. 7A-7C illustrate example embodiments of posterior predictive inference and meta-learning techniques using architectures for self-learning neuro-thermodynamic computers described herein, according to some embodiments.

FIGS. 8A-8C illustrate other example embodiments of posterior predictive inference and meta-learning techniques using architectures for self-learning neuro-thermodynamic computers described herein, wherein inferences are generated for missing data in the test-set data, according to some embodiments.

FIG. 9 illustrates an example hardware implementation of a given multi-chip architecture of a self-learning thermodynamic computer, according to some embodiments.

FIG. 10 is high-level diagram illustrating an example two-chip architecture of a self-learning neuro-thermodynamic computer included in a dilution refrigerator and coupled to a classical computing device in an environment (which may be in the dilution refrigerator or external to the dilution refrigerator), according to some embodiments.

FIG. 11 illustrates an example hardware implementation of a given two-chip architecture of a self-learning neuro-thermodynamic computer, according to some embodiments.

FIG. 12 illustrates a process of performing training and inference generation by applying an energy-based learning protocol to a three-chip architecture, according to some embodiments.

FIG. 13 illustrates a process of performing training and inference generation by applying an energy-based learning protocol to a two-chip architecture, according to some embodiments.

FIG. 14 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and an apparatus for performing computer operations using various multi-thermodynamic chip architectures. In some embodiments, neuro-thermodynamic processors may be configured such that learning algorithms for energy-based models may be applied using Langevin dynamics. For example, as described herein, two, three, or more neuro-thermodynamic processors may be arranged in respective three-dimensional architectures such that, given a series of Hamiltonian and coupling terms, weights and biases (e.g., synapses) may naturally evolve (and thus be learned) through Langevin dynamics.

Furthermore, in some embodiments, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve” degrees of freedom of the oscillators may be sampled. Values of these sampled degrees of freedom may represent, for example, vector values for neurons that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons (e.g., degrees of freedom of the oscillators of the substrate of the thermodynamic chip) directly without having to calculate statistics to determine probabilities. As another example, thermodynamic chips may be used to perform autocomplete tasks, such as those that use Hopfield networks, which may be implemented using the Welling and Teh algorithm. For example, visible neurons may be arranged in a fully connected graph (such as a Hopfield network, etc.), and the values of the auto complete task may be learned using the Welling and Teh algorithm. As another examples, inferred values (e.g. degrees of freedom of oscillators) of a first energy-based model may be relayed as outputs of the first energy-based model, and may further be used as inputs to an additional energy-based model.

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that, for example, have dual-well potentials. These dual-well oscillators may be mapped to neurons of a given model that the thermodynamic chip is being used to implement. Also, in some embodiments, at least some of the oscillators may be harmonic oscillators with single-well potentials. In some embodiments, oscillators may be implemented using superconducting flux elements with varying amounts of non-linearity. In some embodiments, an oscillator may have a single well potential, a dual-well potential, a potential somewhere in a range between a single-well potential and a dual-well potential, or a multi-well potential. In some embodiments, visible neurons may be mapped to oscillators having a single well potential, a dual-well potential, a potential somewhere in a range between a single-well potential and a dual-well potential, or a multi-well potential.

In some embodiments, parameters of an energy based model or other learning algorithm may be learned through evolution of the oscillators of a set of thermodynamic chips that have been configured in a current configuration with couplings that correspond to a current engineered Hamiltonian being used to approximate aspects of the energy-based model for the respective thermodynamic chips. For example, a server thermodynamic chip may use positive and negative phase terms to drive weights and biases of a first thermodynamic chip to approximately match those of a second thermodynamic chip, according to some embodiments. However, in the second thermodynamic chip, visible neurons may be left un-clamped, whereas in the first thermodynamic chip the visible neurons may be clamped to input data. In this way, the weights and biases of a current evolution step influence the un-clamped vision neurons of the second thermodynamic chip, which in turn influence the weights and biases that are maintained the same across the first and second thermodynamic chips. Thus, even though the visible neurons of the first thermodynamic chip are clamped to the input data, the weights and biases are free to evolve to “learn” relationships between the clamed input data via the back-and-forth evolution to the second thermodynamic chip, via the server thermodynamic chip. In this way, updated weightings or biases to be used in the engineered Hamiltonian may be automatically learned via evolution of the multi-chip architecture comprising multiple thermodynamic chips coupled via a server thermodynamic chip. In some embodiments, such updates to weightings and biases may be allowed to evolve until the engineered Hamiltonian of the first thermodynamic chip has been adjusted such that samples taken from the first thermodynamic chip satisfy one or more training criteria for training the first thermodynamic chip such that the first thermodynamic chip accurately implements inferences.

For example, in some embodiments, the engineered Hamiltonian (shown in the equation below) may be implemented using a thermodynamic chip (e.g., a clamped chip, un-clamped chip, etc.) wherein the first term of the Hamiltonian represents visible neurons, the second and third terms represent potentials for weights and biases, and the final two terms of the Hamiltonian represent couplings between the weights and biases and the visible neurons.

In some embodiments, the hardware implementation of the neurons used to encode the data may be based on a flux qubit design. For example, the neuron may be represented by a phase/flux degree of freedom, wherein an oscillator design that implements the phase/flux degree of freedom is based on a DC SQUID (direct current superconducting quantum interference device), for example which contains two junctions. In what follows, Eⱼ will be used to denote the Josephson energy. L corresponds to the inductance of the main loop, and results in the inductive energy E_{L}. \tilde{φ}_{L} is the external flux coupled to the main loop and PDC is the external flux coupled into the DC SQUID loop. The Hamiltonian used to represent the physical neurons, along with how they couple with each other is given by:

$$\begin{matrix}{H}_{total} = {\sum }_{j ∈ {𝒱}_{v i s}} ( \frac{{p}_{{n}_{j}}^{2}}{2 {m}_{{n}_{j}}^{( v )}} + {{E}_{L}^{( v )} ( {φ}_{{n}_{j}} - {\tilde{φ}}_{L}^{( v )} )}^{2} + {E}_{{J}_{0}}^{( v )} cos ( {\tilde{φ}}_{D C}^{( v )} / 2 ) ( 1 - cos ( {φ}_{{n}_{j}} ) ) ) \\ + {\sum }_{k , l ∈ ε} ( \frac{{p}_{{s}_{j}}^{2}}{2 {m}_{{s}_{k , l}}^{( w )}} + {{E}_{L}^{( w )} ( {φ}_{{s}_{k , l}} - {\tilde{φ}}_{L}^{( w )} )}^{2} \\ + {E}_{{J}_{0}}^{( w )} cos ( {\tilde{φ}}_{D C}^{( w )} / 2 ) ( 1 - cos ( {φ}_{{s}_{k , l}} ) ) ) \\ + {\sum }_{j ∈ {𝒱}_{v i s}} ( \frac{{p}_{{b}_{j}}^{2}}{2 {m}_{{b}_{j}}^{( b )}} + {{E}_{L}^{( b )} ( {φ}_{{b}_{j}} - {\tilde{φ}}_{L}^{( b )} )}^{2} \\ + {E}_{{J}_{0}}^{( b )} cos ( {\tilde{φ}}_{D C}^{( b )} / 2 ) ( 1 - cos ( {φ}_{{b}_{j}} ) ) ) \\ + ( α {\sum }_{\{ k , l \}} {φ}_{{s}_{k l}} {φ}_{{n}_{k}} {φ}_{{n}_{l}} + β {\sum }_{j ∈ 𝒱} {φ}_{{n}_{j}} {φ}_{{b}_{j}} ) ,\end{matrix}$$

where [symbol] is the set corresponding to the visible neurons (which are used to encode the data in a given learning algorithm). In some embodiments, a term may be added to the Hamiltonian above, wherein the added term represents hidden neurons in a system. The term relating to hidden neurons may be of similar form as the visible neurons. The set of synapses ε (e.g. weightings and biases) includes the edges representing the couplings between the visible neurons and potentially present hidden neurons. Biases are added to all the visible neurons and potentially present hidden neurons.

In some embodiments, the potentials used in the above Hamiltonian are given by,

$$U ( φ ) = {{E}_{L} ( φ - {\tilde{φ}}_{L} )}^{2} + {E}_{{J}_{0}} cos ( {\tilde{φ}}_{D C} / 2 ) ( 1 - cos ( φ ) ) ,$$

where the parameters E_{L}, Eⱼ₀, \tilde{φ}_{L} and \tilde{φ}_{DC} may be tuned to obtain single well, double well, or multiple well potentials. For instance, if, in a given energy-based model, the data is constrained to take on values that are either +1 or −1, a double well potential for the visible neurons would be most appropriate. For quadratic potentials, the condition \tilde{φ}_{DC}=π may be chosen since this causes the second term to vanish. For double well potentials, a more careful choice of \tilde{φ}_{DC} may be required. Note that the coupling parameters α and β in the Hamiltonian above can take on both positive and negative values. The ability to flip between positive and negative signs may prove useful when developing a self-learning algorithm following Langevin dynamics. In some embodiments, sign flips are used along with squeezing type operations to generate a self-learning algorithm. In other embodiments, residual terms in the approach presented below are of higher order, and thus have much less of an impact on the learning dynamics.

In some embodiments, learning algorithms for energy-based models may be based on the stochastic gradient optimization algorithm of Welling and Teh. Consider a set of N data items X={xᵢ}ᵢ₌₁^{N} with posterior distribution p_{θ}(x)=exp(−ε_{θ}(x))/Z(θ) with the partition function Z(θ)=∫p_{θ}(x)dx. In some embodiments, stochastic gradient algorithms may be combined with Langevin dynamics to obtain a parameter update algorithm that allows for efficient use of large datasets while allowing for parameter uncertainty to be captured in a Bayesian manner. For example, the update rule may be given by,

$${θ}_{t + 1} = {θ}_{t} + \frac{{∈}_{t}}{2} ( \frac{N}{n} {∇}_{{θ}_{t}} log {p}_{{θ}_{t}} ( {x}_{{t}_{i}} ) ) + {η}_{t} ,$$

with nₜ˜N(0,∈ₜ) if no hidden neurons are used. The step sizes Et must satisfy the property Σₜ₌₁^{∞}∈ₜ=∞, and Σₜ₋₁^{∞}∈ₜ²<∞. During learning of weights and biases, using a stochastic gradient algorithm, the first condition ensures that the parameters (e.g. weights and biases) will reach high probability regions regardless of where they are initialized and the second condition ensures the parameters (e.g. weights and biases) converge to the mode instead of oscillating around it. In some embodiments, a functional form which satisfies these requirements is to set ∈ₜ=α(b+t)^{-γ}. Note that at each iteration t, a subset of data items (with size n) Xₜ={xₜ_{₁}, . . . , xₜ_{ₙ}} may be used. Over multiple iterations, the full data set may be used.

In some embodiments using the Hamiltonian above, the energy function may be written as ε_{θ}(x)= [symbol] (θ)+ [symbol] (x)+ε^{(c)}(θ,x), where the energy functions are decomposed into a sum of potential terms for the synapse parameters θ( [symbol] (θ)), the visible neurons ( [symbol] (x)), and (potentially) hidden neurons ( [symbol] (z)), along with coupling terms given by ε^{(c)}(θ,x) or ε^{(c)}(θ,x,z). Using this structure, the gradient of the log likelihood may be computed as follows,
or

$$\begin{matrix}{∇}_{θ} log {p}_{θ} ( x ) = - {∇}_{θ} ( θ ) - {∇}_{θε}^{( c )} ( θ , x ) - \frac{{∇}_{θ} Z ( θ )}{Z ( θ )} \\ = - {∇}_{θ} {ε}^{( {℘}_{1} )} ( θ ) - {∇}_{θ} {ε}^{( c )} ( θ , x ) + {E}_{x ∼ {p}_{θ} ( x )} [ {∇}_{θ} ( θ ) + {∇}_{θ} {ε}^{( c )} ( θ , x ) ] \\ = - {∇}_{θ} {ε}^{( c )} ( θ , x ) + {E}_{x ∼ {p}_{θ} ( x )} [ {∇}_{θ} {ε}^{( c )} ( θ , x ) ] , \\ = - {E}_{z ∼ {p}_{θ} ( x )} [ {∇}_{θ} {ε}^{( c )} ( θ , x , z ) ] + {E}_{( x , z ) ∼ {p}_{θ} ( x , z )} [ {∇}_{θ} {ε}^{( c )} ( θ , x , z ) ] .\end{matrix}$$

Accordingly, only the coupling terms of the Hamiltonian above are relevant in computing the gradient of the log likelihood.

In some embodiments, a parameter update rule may be written as,

$${θ}_{t + 1} = {θ}_{t} - N \frac{{ϵ}_{t}}{2} ( \frac{1}{n} {\sum }_{i = 1}^{n} {∇}_{{θ}_{t}} {ℰ}^{( c )} ( {θ}_{t} , {x}_{{t}_{i}} ) - {E}_{x ∼ {p}_{{θ}_{t} ( x )}} [ {∇}_{{θ}_{t}} {ℰ}^{( c )} ( {θ}_{t} , {x}_{{t}_{i}} ) ] ) + {η}_{t} , or$$

$${θ}_{t + 1} = {θ}_{t} - N \frac{{ϵ}_{t}}{2} ( \frac{1}{n} {\sum }_{i = 1}^{n} {E}_{z ∼ {p}_{θ} ( z \vert x )} [ {∇}_{θ} {ℰ}^{( c )} ( {θ}_{t} , {x}_{{t}_{i}} , z ) ] - {E}_{( x , z ) ∼ {p}_{θ} ( x , z )} [ {∇}_{θ} {ℰ}^{( c )} ( θ , x , z ) ] ) + {η}_{t} .$$

The first term in the large parentheses above is known as the positive phase term, whereas the second term in the above equation is known as the negative phase term. Note the sign difference between the two terms. Note also that the negative phase term requires averaging over sampled values of the visible nodes x from p_{θ}(x). Monte Carlo methods as well as persistent contrastive divergence methods may be employed to sample multiple paths from p_{θ}(x) without having to take too many Monte Carlo steps. A time average approach may also be used to approximate an expectation value for a self-learning algorithm.

In some embodiments, a Hamiltonian description for a three-chip architecture may resemble the following:

$${H}_{total} = {H}_{c} + {H}_{u} + {H}_{s} + {λ}_{1} {\sum }_{j ∈ ε} {( {q}_{j}^{( c )} - {q}_{j}^{( s )} )}^{2} + {λ}_{2} {\sum }_{j ∈ ε} {( {q}_{j}^{( u )} - {q}_{j}^{( s )} )}^{2} + {η}_{1} {\sum }_{j ∈ ε} {( {p}_{j}^{( c )} + {p}_{j}^{( s )} )}^{2} + {η}_{2} {\sum }_{j ∈ ε} {( {p}_{j}^{( u )} - {p}_{j}^{( s )} )}^{2} + {λ}_{3} {\sum }_{j ∈ {V}_{vis}} {( {q}_{j}^{( c )} - {q}_{j}^{( s )} )}^{2} + {λ}_{4} {\sum }_{j ∈ {V}_{vis}} {( {q}_{j}^{( u )} - {q}_{j}^{( s )} )}^{2} + {η}_{3} {\sum }_{j ∈ {V}_{vis}} {( {p}_{j}^{( c )} + {p}_{j}^{( s )} )}^{2} + {η}_{4} {\sum }_{j ∈ {V}_{vis}} {( {p}_{j}^{( u )} - {p}_{j}^{( s )} )}^{2}$$

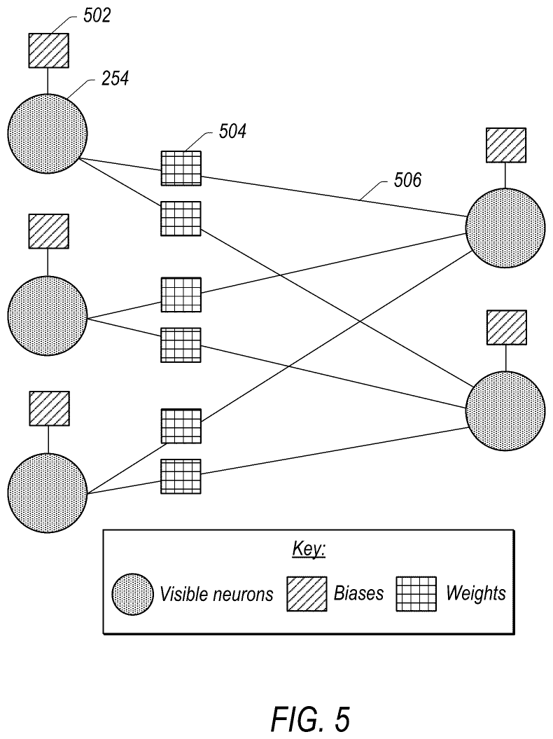

Note that for ease of notation, φₙ_{ⱼ} is replaced with qⱼ. The superscripts “s”, “c” and “u” are also added to distinguish the degrees of freedom belonging to the server, clamped and un-clamped chips. In the above equation, q represents a position, p represents momentum, [symbol] represents vertices, such as the visible neurons 254 shown in FIG. 5, and ¿ represents edges, such as edges 506, that connect the vertices, also as shown in FIG. 5. The neurons may be accompanied by a bias, such as biases 502, and the synapses (weights), such as synapses 504, live on the edges. Also, note that the visible neurons may have different masses and frequencies as compared to the weights and biases. In some embodiments, the system may be overdamped, wherein the γ term may be large. Furthermore, the system may alternatively be allowed to have low friction, such that the γ term may be small by comparison. Measurements (e.g., samples or statistics) taken from the visible neurons (e.g., implemented as oscillators of the substrate of the thermodynamic chip) may provide continuous values or discrete values that correspond to degrees of freedom of the oscillators. For example, a measurement scheme of the visible neurons may resolve whether the position is on the right or left side of the corresponding potential well, which, in turn, may provide a discrete value. Also, in some embodiments, the oscillators oscillate in the giga-hertz (GHz) regime. In some embodiments, measurements may be space averaged and/or time averaged.

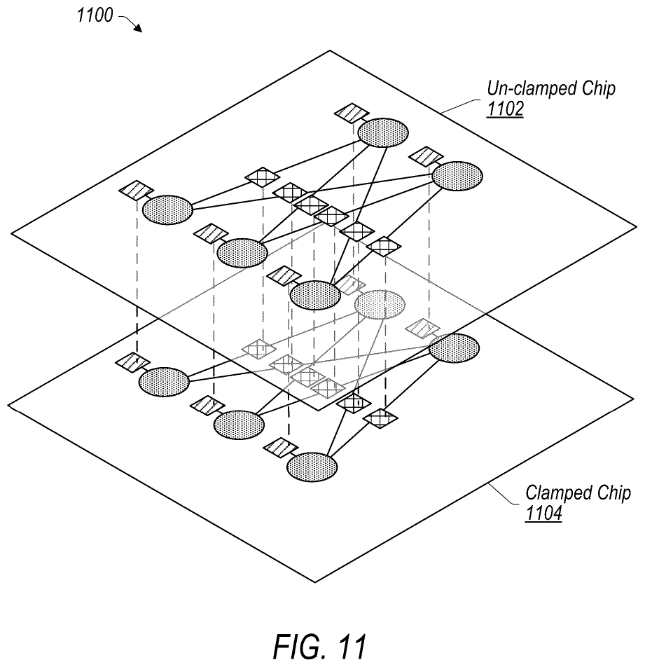

In some embodiments, a Hamiltonian description for a two-chip architecture (as shown in FIG. 11) may resemble the following. A two-chip architecture may refer to a hardware implementation wherein a clamped chip and an un-clamped chip are directly coupled. In such embodiments, weights and biases of both the clamped and un-clamped chips are configured to match, and learning may take place through negative phase terms which evolve during said process.

$${H}_{total} = {H}_{c} + {H}_{u} + {λ}_{1} {\sum }_{j ∈ ε} {( {q}_{j}^{( c )} - {q}_{j}^{( u )} )}^{2} + {η}_{1} {\sum }_{j ∈ ε} {( {p}_{j}^{( c )} + {p}_{j}^{( u )} )}^{2} + {λ}_{2} {\sum }_{j ∈ {V}_{vis}} {( {q}_{j}^{( c )} - {q}_{j}^{( u )} )}^{2} + {η}_{2} {\sum }_{j ∈ {V}_{vis}} {( {p}_{j}^{( c )} + {p}_{j}^{( u )} )}^{2}$$

In some embodiments, the use of a thermodynamic chip in a computer system may enable a learning algorithm to be implemented in a more efficient and faster manner than if the learning algorithm was implemented purely using classical components. For example, measuring the neurons in a thermodynamic chip to determine Langevin statistics may be quicker and more energy efficient than determining such statistics via calculation.

Broadly speaking, classes of algorithms that may benefit from thermodynamic chips include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, multi-chip architectures such as those described herein may resemble a full self-learning architecture, wherein classical computing device(s) (e.g., a GPU, FPGA, etc.) may be replaced with such self-learning neuro-thermodynamic computer(s) in order to implement a full learning algorithm (e.g., the Welling and Teh learning algorithm) without use of such classical computing co-processor(s).

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example, some thermodynamic chips may be operated within the milli-Kelvin range, and/or at 2, 3, 4, etc. degrees Kelvin. In some embodiments, temperatures less than 15 Kelvin may be used. Though other temperatures ranges are also contemplated. This also, in some contexts may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform full self-learning tasks and operations.

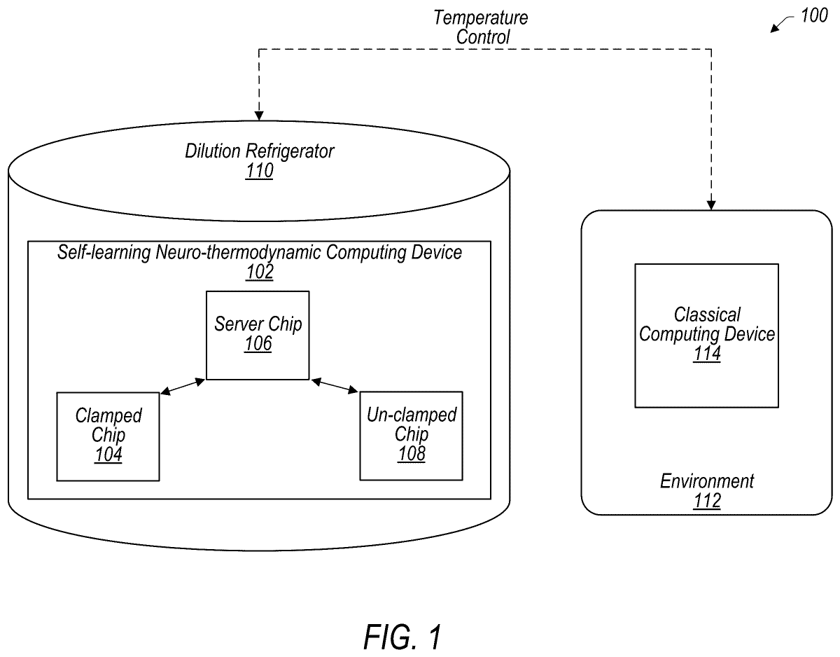

FIG. 1 is high-level diagram illustrating an example three-chip architecture of a self-learning neuro-thermodynamic computer included in a dilution refrigerator and coupled to a classical computing device in an environment (which may be in the dilution refrigerator or external to the dilution refrigerator), according to some embodiments.

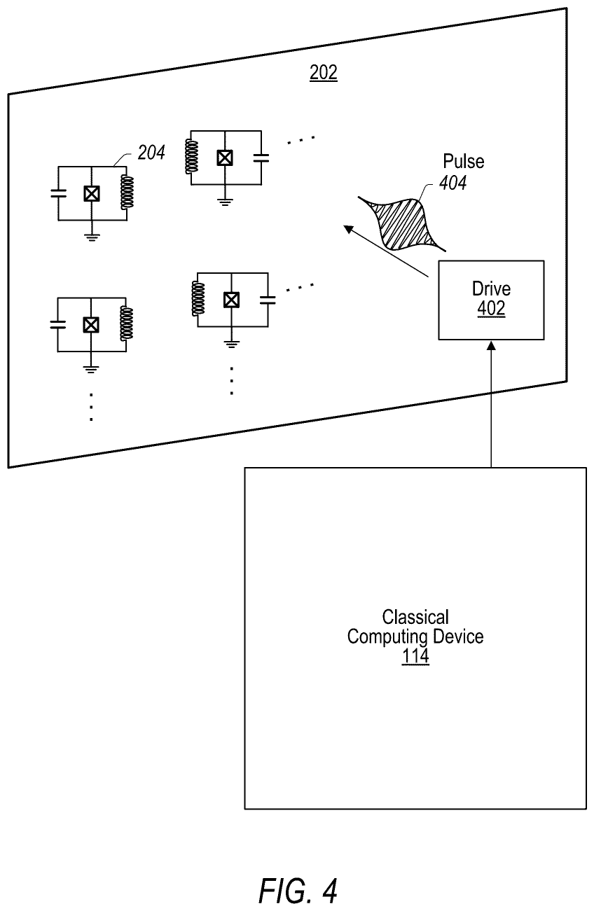

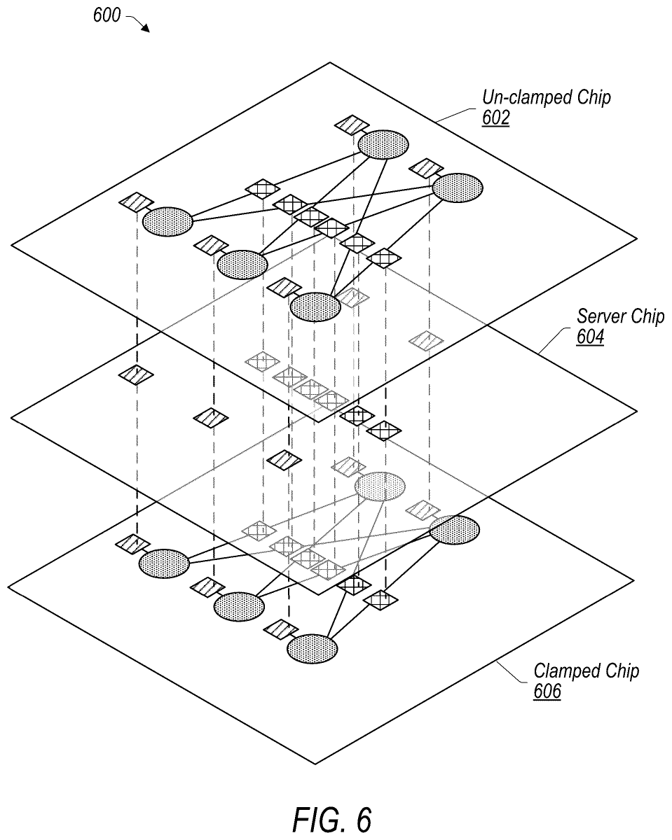

In some embodiments, a thermodynamic computing system 100 (as shown in FIG. 1) may include a self-learning neuro-thermodynamic computing device 102 placed in a dilution refrigerator 110. The self-learning neuro-thermodynamic computing device 102 comprises clamped chip 104, server chip 106, and un-clamped chip 108 arranged in a three-dimensional architecture (see also FIG. 6 described herein) of self-learning neuro-thermodynamic computing device 102. In some embodiments, classical computing device 114 may control temperature for dilution refrigerator 110, and/or perform other tasks, such as helping to drive a pulse drive to change respective hyperparameters of the given system and/or perform measurements, such as shown in FIG. 4.

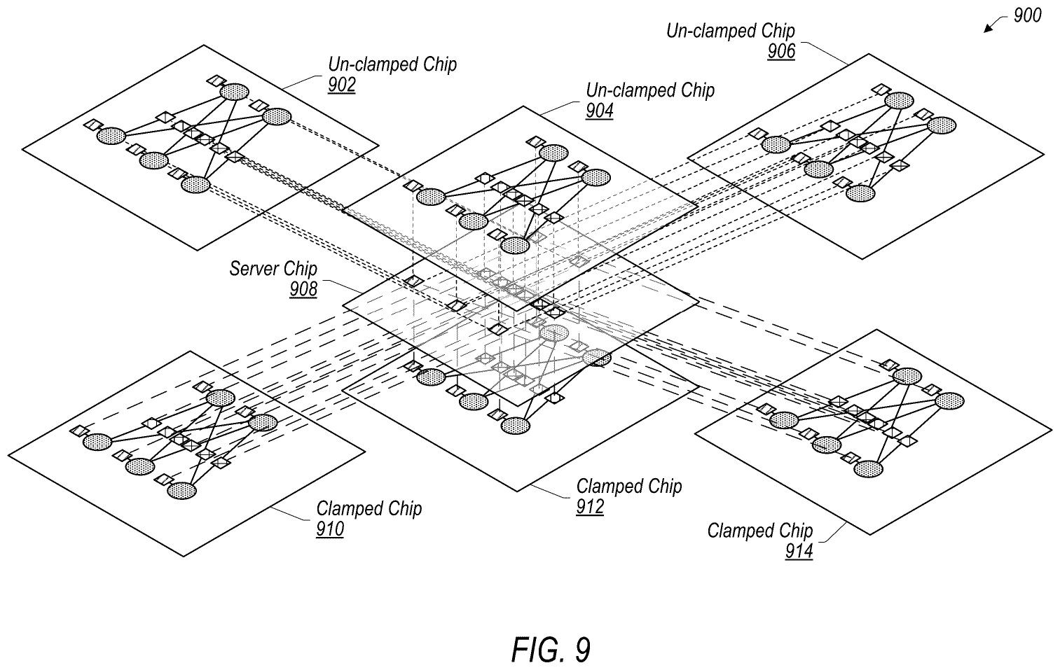

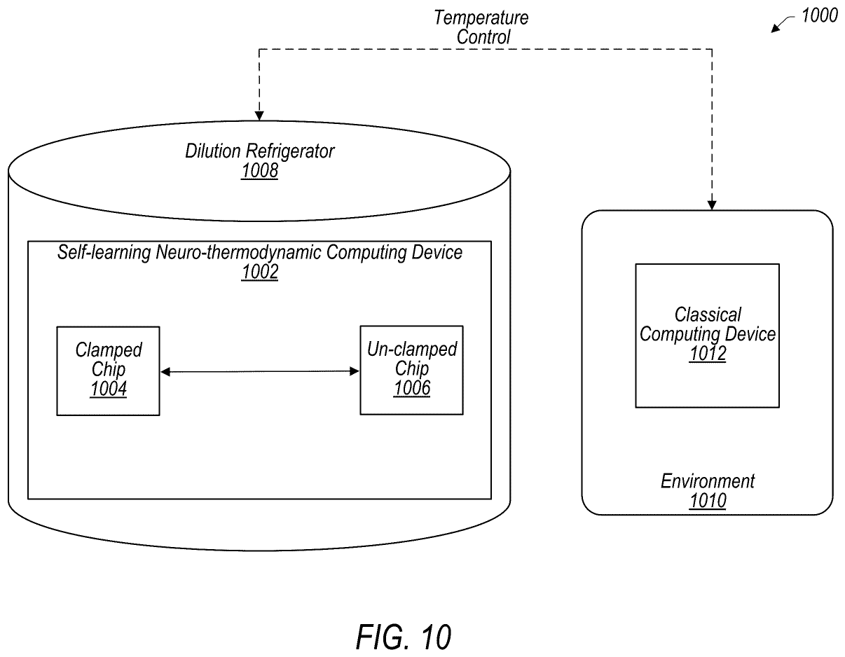

In some embodiments, a self-learning neuro-thermodynamic computing device 102 may include multiple thermodynamic chips, such as clamped chip 104, server chip 106, and un-clamped chip 108. A person having ordinary skill in the art should understand that FIG. 1 resembles example embodiments of such an architecture, and is not meant to be restrictive in terms of other embodiments of the disclosed invention, such as embodiments in which clamped chip(s) and un-clamped chip(s) may be directly coupled (see also FIGS. 10 and 11 described herein), etc. Furthermore, clamped chip 104 may be defined as having visible neurons that are coupled to data, while un-clamped chip 108 may be defined as having visible neurons that evolve freely according to Langevin dynamics. A server chip 106, therefore, may be coupled to both clamped chip 104 and un-clamped chip 108, wherein said coupling may be selected such that an energetic penalty is added if/when position variables of given weights and biases of clamped chip 104, un-clamped chip 108, and server chip 106 do not match. As further described with regard to FIG. 9 herein, some embodiments of a self-learning neuro-thermodynamic computing device 102 may include multiple clamped and un-clamped chips which are coupled to a given server chip. Such embodiments may be used for data parallelization and space averages.

In some embodiments, classical computing device 114 may include one or more devices such as a field-programmable gate array (FPGA), an application specific integrated circuit (ASIC), and/or other devices that may be configured to interact and/or interface with thermodynamic chips within the architecture of self-learning neuro-thermodynamic computer 102. For example, such devices may be used to tune hyperparameters of the given thermodynamic system, etc.

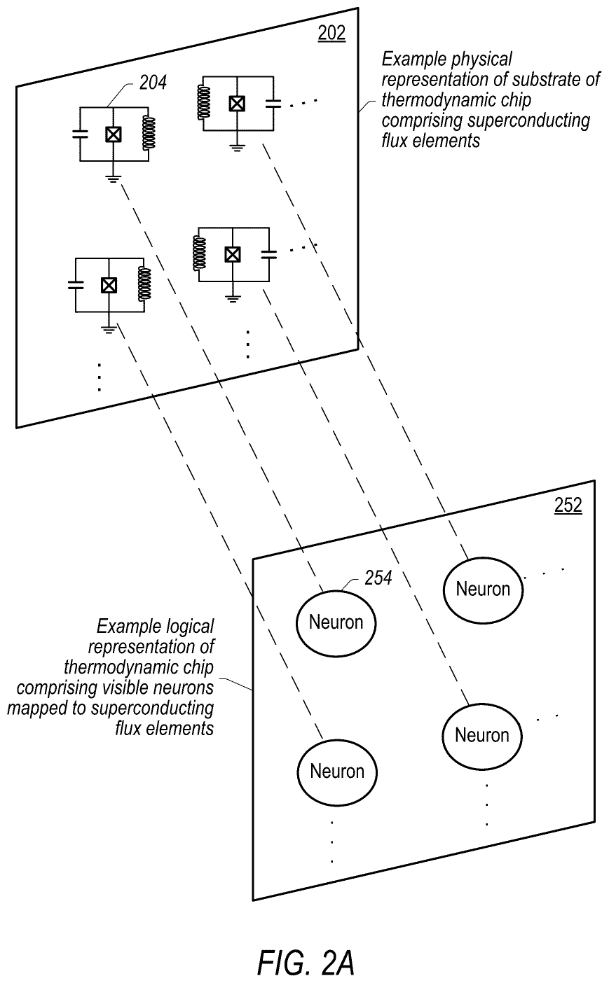

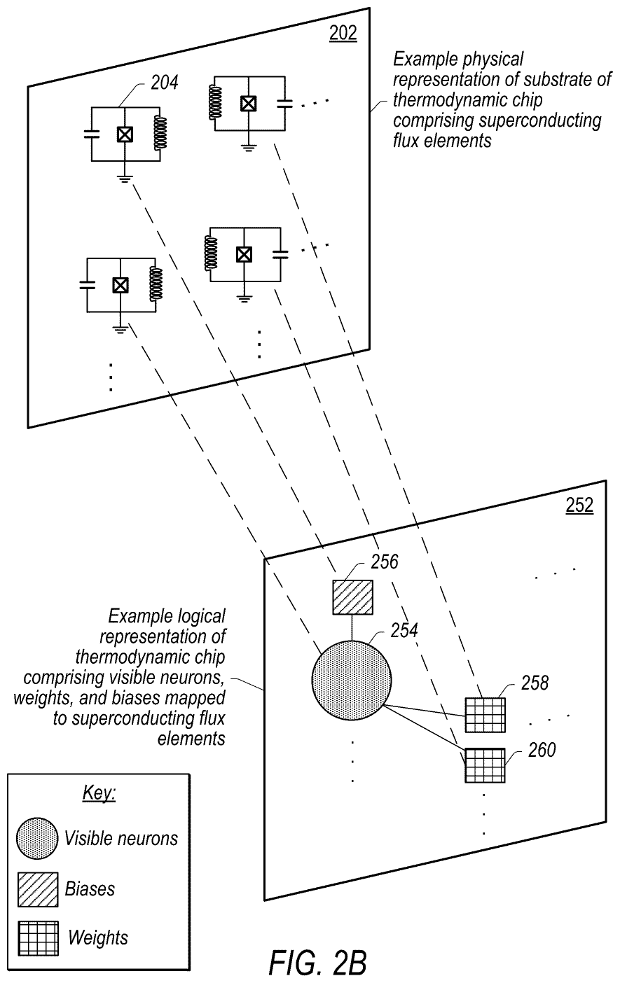

FIG. 2A is a high-level diagram illustrating oscillators included in a substrate of the thermodynamic chip and mapping of the oscillators to logical neurons of the thermodynamic chip, according to some embodiments.

In some embodiments, a substrate 202 may be included in a thermodynamic chip, such as any one of the thermodynamic chips implemented in self-learning neuro-thermodynamic computing device 102. Oscillators 204 of substrate 202 may be mapped in a logical representation 252 to neurons 254, as well as weights and biases (shown in FIG. 2B, and shown in the more detailed view shown in FIG. 5). In some embodiments, oscillators 204 may include oscillators with potential ranging from a single well potential to a dual-well potential (or other types of potentials) and may be mapped to visible and hidden neurons, weights, and biases.

In some embodiments, Josephson junctions and/or superconducting quantum interference devices (SQUIDS) may be used to implement and/or excite/control the oscillators 204. In some embodiments, the oscillators 204 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 2A for oscillator 204. However, in some embodiments, generally speaking various non-linear flux loops may be used to implement the oscillators 204, such as those having single-well potential, double-well potential, or various other potentials, such as a potential somewhere between a single-well potential and a double-well potential.

FIG. 2B is an additional high-level diagram illustrating oscillators included in a substrate of the thermodynamic chip mapped to logical neurons, weights, and biases of a given self-learning neuro-thermodynamic computing system, according to some embodiments.

While weights and biases are not shown in FIG. 2A for ease of illustration, respective ones of the visible neurons 254 of FIG. 2A may each have an associated bias, and edges connecting the neurons 254 may have associated weights. For example, FIG. 5 illustrates an arrangement of five visible neurons along with associated weights and biases. Each of the weights and biases (such as those shown in FIG. 5) may be mapped to oscillators in the clamped chip, un-clamped chip, and server chip. For example, FIG. 2B shows a portion of a chip, such as a clamped chip 104 or an un-clamped chip 108, wherein weights and biases associated with a given neuron 254 are shown. For example, bias 256 may be a bias value for visible neuron 254 and weights 258 and 260 may be weights for edges formed between visible neuron 254 and other visible neurons of the chip. As shown in FIG. 2B, each of the chip elements (visible neuron 254, bias 256, weight 258, and weight 260) may be mapped to separate ones of oscillators 204. This may allow the visible neurons, weights, and biases to have independent degrees of freedom within a given chip that can separately evolve.

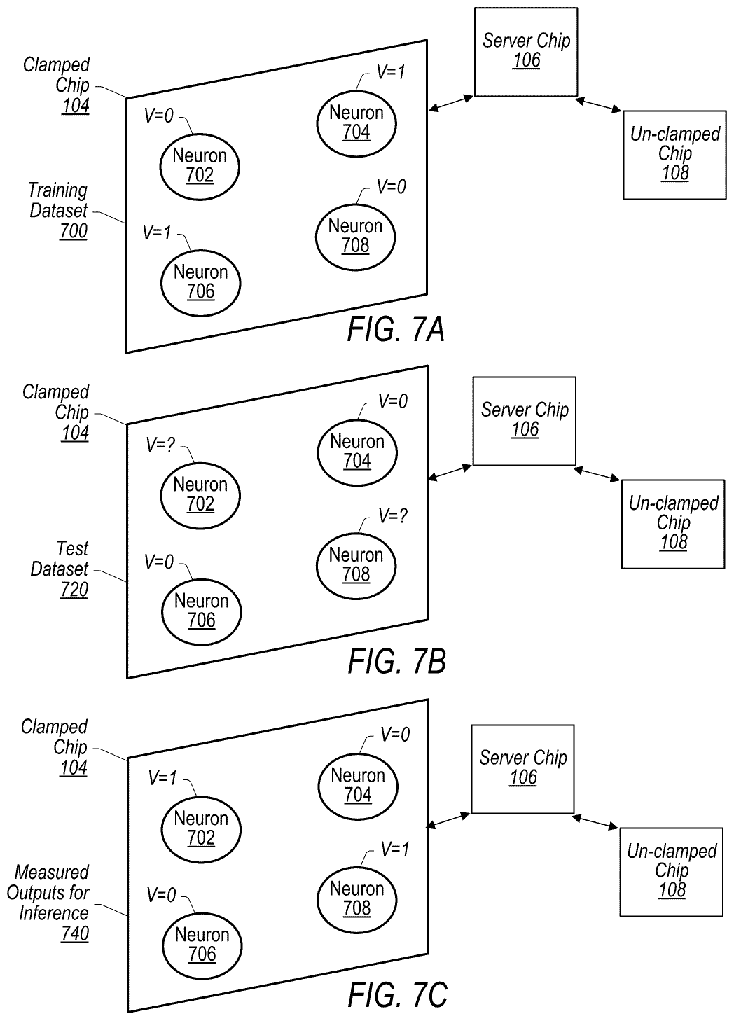

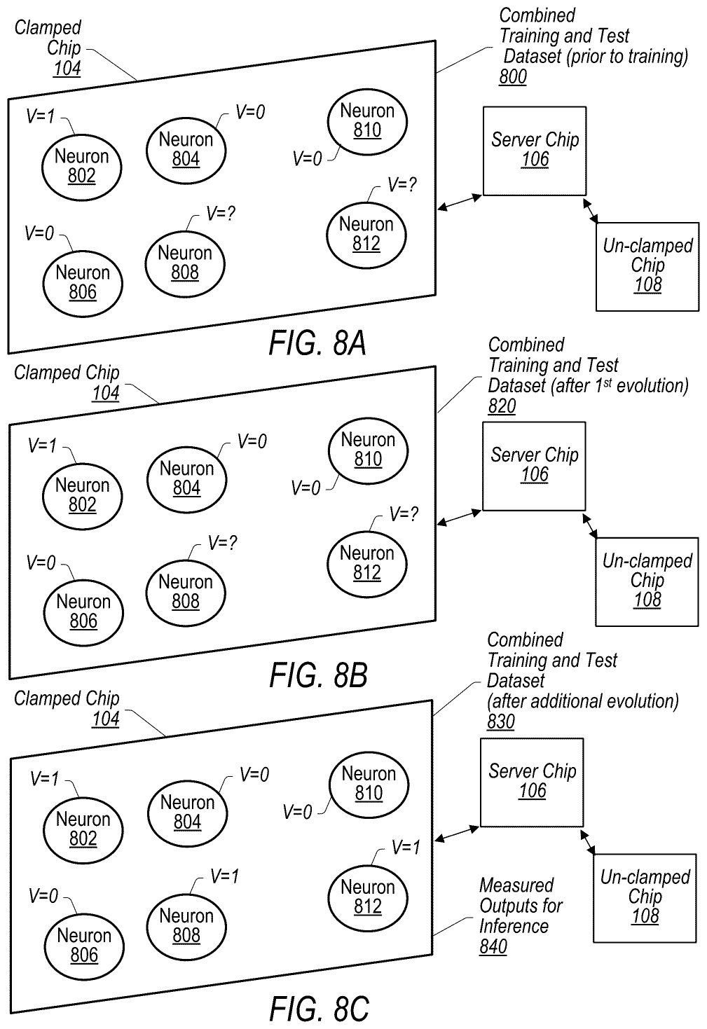

In some embodiments, oscillators associated with weights and biases, such as bias 256 and weights 258 and 260, may be allowed to evolve during a training phase and may be held nearly constant during an inference phase, as further described in FIGS. 7A-7C and 8A-8C. For example, in some embodiments, larger “masses” may be used for the weights and biases such that the weights and biases evolve more slowly than the visible and hidden neurons. This may have the effect of holding the weight values and the bias values nearly constant during an evolution phase used for generating inference values. Alternatively, a pulse drive, such as shown in FIG. 4 may be used to control couplings between visible and hidden neurons using weight values and bias values learned via self-learning as described herein.

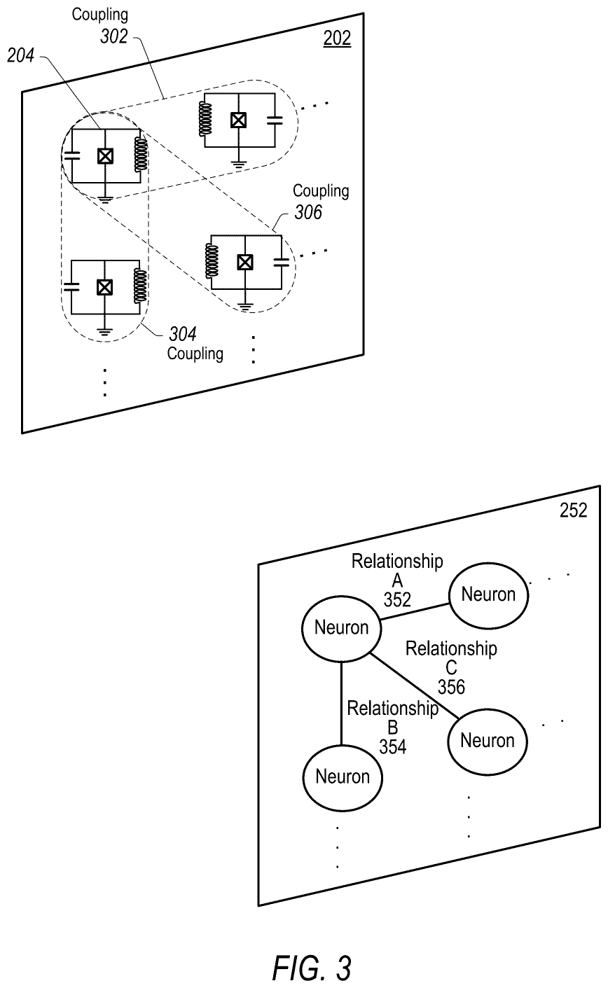

FIG. 3 is a high-level diagram illustrating logical relationships between neurons (or other elements, such as weights or biases) of the thermodynamic chip that are physically implemented via magnetic flux couplings between oscillators of the substrate of the thermodynamic chip, according to some embodiments.

In some embodiments, the self-learning neuro-thermodynamic computing device 102 may learn relationships between respective ones of the neurons such as relationship A (352), relationship B (354), and relationship C (356). These relationships may be physically implemented in substrate 202 via couplings between oscillators 204, such as couplings 302, 304, and 306 that physically implement respective relationships 352, 354, and 356. These learned relationships may comprise learned weights and biases, that are learned via evolution of the self-learning neuro-thermodynamic computing device 102.

FIG. 4 is a high-level diagram illustrating a pulse drive that initializes respective hyperparameters of the given system, according to some embodiments.

In some embodiments, a drive 402 may cause pulses 404 to be emitted to initialize hyperparameters. An FPGA and/or other classical computing device, as represented via classical computing device 114 in FIG. 4, may be applied during a meta-learning algorithm to find new hyperparameters after respective rounds of training/inference steps. For example, a Bayesian black box optimizer algorithm for hyperparameter tuning may be used, and/or hyperparameter gradient estimators.

FIG. 5 illustrates example couplings between visible neurons, weights, and biases (e.g., synapses) of a thermodynamic chip, according to some embodiments.

In some embodiments, visible neurons, such as visible neurons 254, may be linked via connected edges 506. Furthermore, as shown in FIG. 5, such visible neurons may additionally be linked to corresponding biases, such as biases 502, and to weights (synapses), such as synapses 504. Recall that neurons, weights, and biases are logical representations of physical oscillators. Such that when describing neurons, weights, and biases in FIG. 5 it should be understood that these elements are implemented using oscillators and couplings as shown in FIG. 3. In some embodiments, hidden neurons (not shown in FIG. 5) may be coupled between respective other hidden neurons and/or visible neurons via edges.

FIG. 6 illustrates an example hardware implementation of a given three-chip architecture of a self-learning neuro-thermodynamic computer, according to some embodiments.

In some embodiments, a three-chip architecture may resemble that which is shown in FIG. 6, wherein un-clamped chip 602, server chip 604, and clamped chip 606 are configured in a three-dimensional stacked architectural layout formation. A person having ordinary skill in the art should understand that hardware implementation 600 resembles components of self-learning neuro-thermodynamic computing device 102, which resides within dilution refrigerator 110. In addition, server chip 604 may include weights and biases but may be configured without visible neurons. In some embodiments, other architectures, such as a non-stacked architecture may be used. However, a stacked architecture as shown in FIG. 6 may reduce the complexity of wiring control lines between the respective chips.

In some embodiments, a multi-chip thermodynamic processor architecture consists of three chips, each representing a thermodynamic processor. The dynamics of the chips labeled clamped 606 and un-clamped 602 are both governed by a Hamiltonian (e.g. such as shown above). However for the clamped chip, the visible neurons are clamped to data, which can be achieved by setting positions q and momentums p to a value of the data. For the un-clamped chip 602, the visible nodes evolve freely in the sense that the initial condition q=0 is set. Note that for ease of notation, φₙ_{ⱼ} is replaced with qⱼ. The superscripts “s”, “c” and “u” are also added to distinguish the degrees of freedom belonging to the server, clamped and un-clamped chips. Such a chip may be used to obtain a negative phase term (e.g. such as shown above), whereas the clamped chip 606 will be used to obtain a positive phase term (e.g. such as shown above). Lastly, a third chip, server chip 604, couples to both the clamped 606 and un-clamped 602 chip. In particular, the coupling is chosen to add an energetic penalty if position variables of weights and biases in the clamped, un-clamped and server chips are not identical. A momentum coupling term, which forces a positive phase contribution from the clamped chip and a negative phase contribution from the un-clamped chip during the evolution of the parameter degrees of freedom of the server chip, may be added. A full Hamiltonian of the embodied system may be given by,

$${H}_{tot} = {H}_{c} + {H}_{u} + {H}_{s} + {λ}_{1} {\sum }_{j ∈ ℰ} {( {q}_{j}^{( c )} - {q}_{j}^{( s )} )}^{2} + {λ}_{2} {\sum }_{j ∈ ℰ} {( {q}_{j}^{( u )} - {q}_{j}^{( s )} )}^{2} + {η}_{1} {\sum }_{j ∈ ℰ} {( {p}_{j}^{( c )} + {p}_{j}^{( s )} )}^{2} + {η}_{2} {\sum }_{j ∈ ℰ} {( {p}_{j}^{( u )} - {p}_{j}^{( s )} )}^{2} + {λ}_{3} {\sum }_{j ∈ {V}_{vis}} {( {q}_{j}^{( c )} - {q}_{j}^{( s )} )}^{2} + {λ}_{4} {\sum }_{j ∈ {V}_{vis}} {( {q}_{j}^{( u )} - {q}_{j}^{( s )} )}^{2} + {η}_{3} {\sum }_{j ∈ {V}_{vis}} {( {p}_{j}^{( c )} + {p}_{j}^{( s )} )}^{2} + {η}_{4} {\sum }_{j ∈ {V}_{vis}} {( {p}_{j}^{( u )} - {p}_{j}^{( s )} )}^{2} .$$

where H_{c} and Hₛ are Hamiltonians for the clamped and un-clamped chips given by a Hamiltonian (e.g. such as shown above). Note that for ease of notation, φₙ_{ⱼ} is replaced with qⱼ. The superscripts “s”, “c” and “u” are also added to distinguish the degrees of freedom belonging to the server, clamped and un-clamped chips. The server Hamiltonian Hₛ is given by,

$${H}_{s} = {\sum }_{j ∈ ℰ}^{} \frac{{( {p}_{j}^{( s )} )}^{2}}{2 {m}_{j}^{( s )}} + {\sum }_{j ∈ {V}_{vis}}^{} \frac{{( {p}_{j}^{( s )} )}^{2}}{2 {m}_{j}^{( s )}} + {\sum }_{k , l ∈ ℰ}^{} ( \frac{{p}_{{s}_{j}}^{2}}{2 {m}_{{s}_{k , l}}^{( w )}} + {{E}_{L}^{( w )} ( {φ}_{{s}_{k , l}} - {\tilde{φ}}_{L}^{( w )} )}^{2} + {E}_{j 0}^{( w )} cos ( {\tilde{φ}}_{DC}^{( w )} / 2 ) ( 1 - cos ( {φ}_{{s}_{k , l}} ) ) ) + {\sum }_{j ∈ {V}_{vis}}^{} ( \frac{{p}_{{b}_{j}}^{2}}{2 {m}_{{b}_{j}}^{( b )}} + {{E}_{L}^{( b )} ( {φ}_{{b}_{j}} - {\tilde{φ}}_{L}^{( b )} )}^{2} + {E}_{j 0}^{( b )} cos ( {\tilde{φ}}_{DC}^{( b )} / 2 ) ( 1 - cos ( {φ}_{{b}_{j}} ) ) ) .$$

wherein, the server Hamiltonian contains potential terms similar to those used for the clamped and un-clamped chips. However, the weights and bias degrees of freedom of the server chip are not coupled to any visible or hidden neurons. The final terms in equation Hₜₒₜ above represent couplings between the position degrees of freedom of the server chip and the clamped and un-clamped chips, as well as the momentum couplings between the server chip and the clamped and un-clamped chips. Note that the sums over [symbol] in the coupling terms are used for the bias terms and should not be confused with the visible neurons.

In some embodiments such as given above, to show that a Hamiltonian results in parameter update rules (e.g. such as shown in θₜ₊₁ above), with parameters being represented by the synapses and biases, the Euler-Maruyama method with time steps of size δt may be applied to the Langevin equations of motion to obtain weakly first order solutions. Provided below are solutions to the position and momentum variables of the synapses (identical solutions can be found for the biases) for all three chips. Solutions will be provided for several increments of time δt until the time evolution pattern becomes clear.

In some embodiments, general equations of motion for position variables of the clamped 606 and un-clamped 602 chip are given by,

$$\frac{d {q}_{k} ( t )}{dt} = \frac{\partial {H}_{tot}}{\partial {p}_{k}}$$

$$\frac{d {q}_{k} ( t )}{dt} = - γ {p}_{k} ( t ) - \frac{\partial {H}_{tot}}{\partial {q}_{k}} {\vert}_{t} + \sqrt{2 {m}_{k} γ {k}_{B} T} \frac{{dW}_{t}}{dt} ,$$

where Wₜ is a Wienner process. Note that it is assumed that respective rates of change of a position degrees of freedom of visible nodes are faster compared to synapses and biases (e.g. using a smaller mass for the visible nodes, and note that when using a DC SQUID design, masses are given by m=ϕ₀²C, where C is a capacitance in parallel to a junction/DC SQUID, and ϕ₀=h/2e is a reduced magnetic flux. Note that e is the elementary charge.). In such an embodiment, the position degrees of freedom for the un-clamped system to leading order in δt may be written as,

$${p}_{k}^{( u )} ( t + δ t ) = ( 1 - γ δ t ) {p}_{k}^{( u )} ( t ) - δ t {E}_{δ t} [ \frac{\partial {H}_{tot}}{\partial {q}_{k}^{( u )}} {\vert}_{t} ] + \sqrt{2 {m}_{k} γ {k}_{B} T δ t} {η}_{t} ,$$

$${E}_{δ t} [ \frac{\partial {H}_{tot}}{\partial {q}_{k}^{( u )}} {\vert}_{t} ] \approx \frac{1}{δ t} {\int }_{t}^{t + δ t} \frac{\partial {H}_{tot} ( x ( τ ) )}{\partial {q}_{k}^{( u )}} d τ ,$$

corresponds to a time average of

$$\frac{\partial H ( x ( τ ) )}{\partial q}$$

over a time interval δt, wherein the dependence on the visible nodes is labeled as x instead of q. The generalized Jacboi (G-JF) method is a numerical integration method for solving a stochastic differential equation (SDE) of the general equations of motion (e.g. such as shown above) that is weakly second order (the standard Euler-Maruyama method is weakly first order). In some embodiments, the G-JF method may be used to solve the equations of motion for a three-chip architecture (e.g. such as shown above). The position and momentum equations of motion are given by

$${q}_{k} ( t + δ t ) = {q}_{k} ( t ) + b δ t \frac{\partial H}{\partial {p}_{k}} {\vert}_{t} - \frac{{b ( δ t )}^{2}}{2 {m}_{k}} \frac{\partial H}{\partial {q}_{k}} {\vert}_{t} + \frac{b {σ ( δ t )}^{3 / 2}}{2 \sqrt{{m}_{k}}} {η}_{t}^{( k )} ,$$

$${p}_{k} ( t + δ t ) = {ap}_{k} ( t ) - \frac{δ t}{2} ( a \frac{\partial H}{\partial {q}_{k}} {\vert}_{t} + \frac{\partial H}{\partial {q}_{k}} {\vert}_{t + δ t} ) + b σ \sqrt{{m}_{k} δ t} {η}_{t}^{( k )} ,$$

$$where σ = \sqrt{2 {k}_{b} T γ} , {η}_{t}^{( k )} ∼ N ( 0 , 1 ) and ,$$

$$a ≡ \frac{1 - γ δ t / 2}{1 + γ δ t / 2}$$

$$b ≡ \frac{1}{1 + γ δ t / 2} .$$

In the large friction limit, such equations reduce to,

$${q}_{k} ( t + δ t ) = {q}_{k} ( t ) + \frac{δ t}{2} \frac{\partial H}{\partial {p}_{k}} {\vert}_{t} - \frac{{( δ t )}^{2}}{4 {m}_{k}} \frac{\partial H}{\partial {q}_{k}} {\vert}_{t} + \frac{δ t}{2} \sqrt{\frac{{k}_{B} T}{{m}_{k}}} {η}_{t}^{( k )} ,$$

$${p}_{k} ( t + δ t ) = - \frac{δ t}{2} \frac{\partial H}{\partial {q}_{k}} {\vert}_{t + δ t} + \sqrt{{m}_{k} {k}_{B} T} {η}_{k}^{( k )} .$$

Using the immediately above two equations, the position and momentum equations of motion for the server, clamped and un-clamped chips are,

$${q}_{k}^{( s )} ( t + δ t ) = {q}_{k}^{( s )} ( t ) + δ t ( \frac{{p}_{k}^{( s )} ( t )}{2 {m}_{k}^{( s )}} + {η}_{1} ( {p}_{k}^{( c )} ( t ) + {p}_{k}^{( s )} ( t ) ) - {η}_{2} ( {p}_{k}^{( u )} ( t ) + {p}_{k}^{( s )} ( t ) ) ) + \frac{{( δ t )}^{2}}{2 {m}_{k}^{( s )}} ( {λ}_{1} ( {q}_{k}^{( c )} ( t ) - {q}_{k}^{( s )} ( t ) ) + {λ}_{2} ( {q}_{k}^{( u )} ( t ) - {q}_{k}^{( s )} ( t ) ) - \frac{1}{2} \frac{\partial {H}_{s}}{\partial {q}_{k}^{( s )}} {\vert}_{t} ) + \frac{δ t}{2} \sqrt{\frac{{k}_{B} T}{{m}_{k}^{( s )}}} {η}_{t}^{( k )} ,$$

$${p}_{k}^{( s )} ( t + δ t ) = δ t ( {λ}_{1} ( {q}_{k}^{( c )} ( t + δ t ) - {q}_{k}^{( s )} ( t + δ t ) ) + {λ}_{2} ( {q}_{k}^{( u )} ( t + δ t ) - {q}_{k}^{( s )} ( t + δ t ) ) - \frac{1}{2} \frac{\partial {H}_{s}}{\partial {q}_{k}^{( s )}} {\vert}_{t + δ t} ) + \sqrt{{m}_{k}^{( s )} {k}_{B} T} {η}_{t}^{( k )} ,$$

$${q}_{k}^{( c )} ( t + δ t ) = {q}_{k}^{( c )} ( t ) + \frac{δ t}{2} ( \frac{{p}_{k}^{( c )}}{{m}_{k}^{( c )}} + 2 {η}_{1} ( {p}_{k}^{( c )} ( t ) + {p}_{k}^{( s )} ( t ) ) ) - \frac{{( δ t )}^{2}}{4 {m}_{k}^{( c )}} ( \frac{\partial {H}_{c}}{\partial {q}_{k}^{( c )}} {\vert}_{t} + 2 {λ}_{1} ( {q}_{k}^{( c )} ( t ) - {q}_{k}^{( s )} ( t ) ) ) + \frac{δ t}{2} \sqrt{\frac{{k}_{B} T}{{m}_{k}^{( s )}}} {η}_{t}^{( k )} ,$$

$${p}_{k}^{( c )} ( t + δ t ) = - \frac{δ t}{2} ( \frac{\partial {H}_{c}}{\partial {q}_{k}^{( c )}} {\vert}_{t + δ t} + 2 {λ}_{1} ( {q}_{k}^{( c )} ( t + δ t ) - {q}_{k}^{( s )} ( t + δ t ) ) ) + \sqrt{{m}_{k}^{( c )} {k}_{B} T} {η}_{t}^{( k )} ,$$

$${q}_{k}^{( u )} ( t + δ t ) = {q}_{k}^{( u )} ( t ) + \frac{δ t}{2} ( \frac{{p}_{k}^{( u )} ( t )}{{m}_{k}^{( u )}} + 2 {η}_{2} ( {p}_{k}^{( u )} ( t ) - {p}_{k}^{( s )} ( t ) ) ) - \frac{{( δ t )}^{2}}{4 {m}_{k}^{( u )}} ( {E}_{δ t} [ \frac{\partial {H}_{u}}{\partial {q}_{k}^{( u )}} {\vert}_{t} ] + 2 {λ}_{2} ( {q}_{k}^{( u )} ( t ) - {q}_{k}^{( s )} ( t ) ) ) + \frac{δ t}{2} \sqrt{\frac{{k}_{B} T}{{m}_{k}^{( s )}}} {η}_{t}^{( k )} ,$$

$${p}_{k}^{( u )} ( t + δ t ) = - \frac{δ t}{2} ( {E}_{δ t} [ \frac{\partial {H}_{u}}{\partial {q}_{k}^{( u )}} {\vert}_{t + δ t} ] + 2 {λ}_{2} ( {q}_{k}^{( u )} ( t + δ t ) - {q}_{k}^{( s )} ( t + δ t ) ) ) + \sqrt{{m}_{k}^{( u )} {k}_{B} T} {η}_{t}^{( k )} .$$

Note that under the Born-Oppenheimer approximation, the time averages above may be replaced with space averages. By inserting the momentum terms into the equations for the position degrees of freedom, the above simplifies to (where the noise terms are omitted to keep the equations simple)

$${q}^{( s )} ( t + δ t ) = {q}^{( s )} ( t ) - \frac{{( δ t )}^{2}}{2 {m}_{k}^{( s )}} ( \frac{\partial {H}_{s}}{\partial {q}_{k}^{( s )}} {\vert}_{t} + {m}_{k}^{( s )} {η}_{1} \frac{\partial {H}_{c}}{\partial {q}_{k}^{( c )}} {\vert}_{t} - {m}_{k}^{( s )} {η}_{2} {E}_{δ t} [ \frac{\partial {H}_{u}}{\partial {q}_{k}^{( u )}} {\vert}_{t} ] + 2 {λ}_{1} {q}^{( c )} ( t ) ( 1 + {m}_{k}^{( s )} {η}_{2} ) + 2 {λ}_{2} {q}^{( u )} ( t ) ( 1 + {m}_{k}^{( s )} ( {η}_{1} + 2 {η}_{2} ) ) - 2 {q}^{( s )} ( t ) ( {λ}_{1} ( 1 + {m}_{k}^{( s )} {η}_{2} ) + {λ}_{2} ( 1 + {m}_{k}^{( s )} ( {η}_{1} + 2 {η}_{2} ) ) ) ) .$$

$${q}^{( c )} ( t + δ t ) = {q}^{( c )} ( t ) - \frac{{( δ t )}^{2}}{2 {m}_{k}^{( c )}} ( {m}_{k}^{( c )} {η}_{1} \frac{\partial {H}_{s}}{\partial {q}_{k}^{( s )}} {\vert}_{t} + ( 1 + {m}_{k}^{( c )} {η}_{1} ) \frac{\partial {H}_{c}}{\partial {q}_{k}^{( c )}} {\vert}_{t} + 2 {λ}_{1} ( {q}^{( c )} ( t ) - {q}^{( s )} ( t ) ) + 2 {m}_{k}^{( c )} {η}_{1} {λ}_{2} ( {q}^{( s )} ( t ) - {q}^{( u )} ( t ) ) ) ,$$

$${q}^{( u )} ( t + δ t ) = {q}^{( u )} ( t ) - \frac{{( δ t )}^{2}}{2 {m}_{k}^{( u )}} ( - {m}_{k}^{( u )} {η}_{2} \frac{\partial {H}_{s}}{\partial {q}_{k}^{( s )}} {\vert}_{t} + ( 1 + {m}_{k}^{( u )} {η}_{2} ) {E}_{δ t} [ \frac{\partial {H}_{u}}{\partial {q}_{k}^{( u )}} {\vert}_{t} ] + 2 {λ}_{2} ( {q}^{( u )} ( t ) - {q}^{( s )} ( t ) ) + 2 {m}_{k}^{( u )} {η}_{2} ( {λ}_{1} {q}^{( c )} ( t ) + 2 {λ}_{2} {q}^{( u )} ( t ) - ( {λ}_{1} + 2 {λ}_{2} ) {q}^{( s )} ( t ) ) ) .$$

A few remarks are in order. First, it is noted that if λ₁=λ₂, η₁=η₂ and q^{(s)}(t)=q^{(u)}(t)=q^{(c)}(t), then q^{(s)}(t+δt) simplifies to,

$${q}^{( s )} ( t + δ t ) \approx {q}^{( s )} ( t ) - {( δ t )}^{2} [ ( η + \frac{1}{2 m} ) \frac{\partial {H}_{s}}{\partial {q}_{k}^{( s )}} {\vert}_{t} + \frac{η}{2} ( \frac{\partial {H}_{c}}{\partial {q}_{k}^{( c )}} {\vert}_{t} - {E}_{δ t} [ \frac{\partial {H}_{u}}{\partial {q}_{k}^{( u )}} {\vert}_{t} ] ] ) ,$$

since the remaining terms all cancel. Note that the condition q^{(s)}(t)=q^{(u)}(t)=q^{(c)}(t) can be achieved using a large coupling parameter λ relative to the gradients. It is also noted that q^{(s)} has a form analogous to the Welling and Teh update rule. Hence the above conditions on the λ and n parameters can allow for a full self-learning protocol. Lastly, the term proportional to ∂Hₛ/∂q^{(S)} in q^{(s)} can be interpreted as a log prior term which arises from the potential terms in the server chip Hamiltonian.

Lastly, in what follows, it is pointed out that for the Gibbs distribution of the three-chip system introduced in this section to be a steady state of the Fokker-Planck equation, the noise matrix D representing the noise across the three chips is chosen to be non-diagonal.

The Fokker-Planck equation is given by,

$$\frac{\partial Q ( q , p , τ )}{\partial τ} = ℒ Q ( q , p , τ ) where ,$$

$$ℒ Q ( q , p , τ ) = - {\sum }_{i} \frac{\partial H}{\partial {p}_{i}} \frac{\partial Q}{\partial {q}_{i}} - {\sum }_{i} \frac{\partial }{\partial {p}_{i}} ( ( - \frac{\partial H}{\partial {q}_{i}} - {\sum }_{k} {Γ}_{ik} {p}_{k} ) Q ) + {\sum }_{i , j} {( {{D}^{\frac{1}{2}} ( {D}^{\frac{1}{2}} )}^{T} )}_{ij} \frac{{\partial }^{2} Q}{\partial {p}_{i} \partial {p}_{j}} .$$

For example, consider the server chip coupled to clamped and un-clamped chips. Considering this, the Hamiltonian for the three chip system can be written as,

$${H}_{tot} = {H}_{c} + {H}_{u} + {H}_{s} + λ {\sum }_{j ∈ ℰ} {( {q}_{j}^{( c )} - {q}_{j}^{( s )} )}^{2} + λ {\sum }_{j ∈ ℰ} {( {q}_{j}^{( u )} - {q}_{j}^{( s )} )}^{2} + η {\sum }_{j ∈ ℰ} {( {p}_{j}^{( c )} + {p}_{j}^{( s )} )}^{2} + η {\sum }_{j ∈ ℰ} {( {p}_{j}^{( u )} - {p}_{j}^{( s )} )}^{2} .$$

For brevity, the un-clamped chip is labeled with the superscript u instead of uc. Note that the server chip does not contain hidden or visible neurons, it only has weights and biases and it's purpose is to generate the desired gradient updates on the clamped and un-clamped chips. Given a Hamiltonian of a server, Q is given by,

$$Q = \frac{{e}^{- β {H}_{tot} ( {q}^{( c )} , {q}^{( s )} , {q}^{( u )} , {p}^{( c )} , {p}^{( s )} , {p}^{( u )} , z , x )}}{Z ( x )} ,$$

where the position and momentum degrees of freedom are explicitly labeled.

The relevant derivatives are now given by.

$$\frac{\partial {H}_{tot}}{\partial {p}_{i}^{( c )}} = \frac{{p}_{i}^{( c )}}{m} + 2 η ( {p}_{i}^{( c )} + {p}_{i}^{( s )} )$$

$$\frac{\partial {H}_{tot}}{\partial {q}_{i}^{( c )}} = \frac{\partial {H}_{c}}{\partial {q}_{i}^{( c )}} + 2 λ ( {q}_{i}^{( c )} - {q}_{i}^{( s )} )$$

$$\frac{\partial {H}_{tot}}{\partial {p}_{i}^{( s )}} = \frac{{p}_{i}^{( s )}}{m} + 2 η ( {p}_{i}^{( c )} + 2 {p}_{i}^{( s )} - {p}_{i}^{( u )} )$$

$$\frac{\partial {H}_{tot}}{\partial {q}_{i}^{( s )}} = \frac{\partial {H}_{s}}{\partial {q}_{i}^{( s )}} - 2 λ ( {q}_{i}^{( c )} - 2 {q}_{i}^{( s )} + {q}_{i}^{( u )} )$$

$$\frac{\partial {H}_{tot}}{\partial {p}_{i}^{( u )}} = \frac{{p}_{i}^{( u )}}{m} + 2 η ( {p}_{i}^{( u )} - {p}_{i}^{( s )} )$$

$$\frac{\partial {H}_{tot}}{\partial {q}_{i}^{( u )}} = \frac{\partial {H}_{u}}{\partial {q}_{i}^{( u )}} + 2 λ ( {q}_{i}^{( u )} - {q}_{i}^{( s )} )$$

Next the derivatives of Q as defined herein are computed. This gives.

$$\frac{\partial Q}{\partial {p}_{i}^{( c )}} = - β ( \frac{{p}_{i}^{( c )}}{m} + 2 η ( {p}_{i}^{( c )} + {p}_{i}^{( s )} ) ) Q$$

$$\frac{\partial {Q}_{t o t}}{\partial {q}_{i}^{( c )}} = - β ( \frac{\partial {H}_{c}}{\partial {q}_{i}^{( c )}} + 2 λ ( {q}_{i}^{( c )} - {q}_{i}^{( s )} ) ) Q$$

$$\frac{\partial {Q}_{tot}}{\partial {p}_{i}^{( s )}} = - β ( \frac{{p}_{i}^{( s )}}{m} + 2 η ( {p}_{i}^{( c )} + 2 {p}_{i}^{( s )} - {p}_{i}^{( u )} ) ) Q$$

$$\frac{\partial {Q}_{tot}}{\partial {q}_{i}^{( s )}} = - β ( \frac{\partial {H}_{s}}{\partial {q}_{i}^{( s )}} - 2 λ ( {q}_{i}^{( c )} - 2 {q}_{i}^{( s )} + {q}_{i}^{( u )} ) ) Q$$

$$\frac{\partial {Q}_{tot}}{\partial {p}_{i}^{( u )}} = - β ( \frac{{p}_{i}^{( u )}}{m} + 2 η ( {p}_{i}^{( u )} - {p}_{i}^{( s )} ) ) Q$$

$$\frac{\partial {Q}_{tot}}{\partial {q}_{i}^{( u )}} = - β ( \frac{\partial {H}_{u}}{\partial {q}_{i}^{( u )}} + 2 λ ( {q}_{i}^{( u )} - {q}_{i}^{( s )} ) ) Q .$$

In addition, the relevant second order derivatives of the momentum are written as follows,

$$\frac{{\partial }^{2} Q}{\partial {( {p}_{i}^{( c )} )}^{2}} = - β ( \frac{1}{m} + 2 η ) Q + {{β}^{2} ( \frac{{p}_{i}^{( c )}}{m} + 2 η ( {p}_{i}^{( c )} + {p}_{i}^{( s )} ) )}^{2} Q$$

$$\frac{{\partial }^{2} Q}{\partial {p}_{i}^{( c )} \partial {p}_{i}^{( s )}} = - 2 βη Q + {β}^{2} ( \frac{{p}_{i}^{( c )}}{m} + 2 η ( {p}_{i}^{( c )} + {p}_{i}^{( s )} ) ) ( \frac{{p}_{i}^{( s )}}{m} + 2 η ( {p}_{i}^{( c )} + 2 {p}_{i}^{( s )} - {p}_{i}^{( u )} ) ) Q$$

$$\frac{{\partial }^{2} Q}{\partial {( {p}_{i}^{( s )} )}^{2}} = - β ( \frac{1}{m} + 4 η ) Q + {{β}^{2} ( \frac{{p}_{i}^{( s )}}{m} + 2 η ( {p}_{i}^{( c )} + 2 {p}_{i}^{( s )} - {p}_{i}^{( u )} ) )}^{2} Q$$

$$\frac{{\partial }^{2} Q}{\partial {p}_{i}^{( s )} \partial {p}_{i}^{( u )}} = 2 βη Q + {β}^{2} ( \frac{{p}_{i}^{( s )}}{m} + 2 η ( {p}_{i}^{( c )} + 2 {p}_{i}^{( s )} - {p}_{i}^{( u )} ) ) ( \frac{{p}_{i}^{( u )}}{m} + 2 η ( {p}_{i}^{( u )} - {p}_{i}^{( s )} ) ) Q$$

$$\frac{{\partial }^{2} Q}{\partial {( {p}_{i}^{( u )} )}^{2}} = - β ( \frac{1}{m} + 2 η ) Q + {{β}^{2} ( \frac{{p}_{i}^{( u )}}{m} + 2 η ( {p}_{i}^{( u )} - {p}_{i}^{( s )} ) )}^{2} Q .$$

Before moving forward, the Pokker-Plank operator may be re-written as follows,

$$ℒ Q ( q , p , τ ) = - {\sum }_{i} \frac{\partial H}{\partial {p}_{i}} \frac{\partial Q}{\partial {q}_{i}} + {\sum }_{i} \frac{\partial Q}{\partial {p}_{i}} \frac{\partial H}{\partial {q}_{i}} + {\sum }_{i} {Γ}_{ii} Q + {\sum }_{i} {\sum }_{k} {Γ}_{ik} {p}_{k} \frac{\partial Q}{\partial {p}_{i}} + {\sum }_{i , j} {( {{D}^{\frac{1}{2}} ( {D}^{\frac{1}{2}} )}^{T} )}_{ij} \frac{{\partial }^{2} Q}{\partial {p}_{i} \partial {p}_{j}} .$$

Now due to the symmetry in the derivatives, the first two terms vanish. As such, the Fokker-Plank operator simplifies to,

$$ℒ Q ( q , p , τ ) = {\sum }_{i} {Γ}_{ii} Q + {\sum }_{i} {\sum }_{k} {Γ}_{ik} {p}_{k} \frac{\partial Q}{\partial {p}_{i}} + {\sum }_{i , j} {( {{D}^{\frac{1}{2}} ( {D}^{\frac{1}{2}} )}^{T} )}_{ij} \frac{{\partial }^{2} Q}{\partial {p}_{i} \partial {p}_{j}} .$$

Next the above derivatives are inserted into the Fokker-Plank operator. For a given index i, the contribution arising from the server, clamped and un-clamped chip is computed, and all three of the results are summed due to the corresponding couplings between the three chips. In what follows it is assumed that Γ is diagonal. First, start by writing the i′th term in the sum of [symbol] Q for the server chip,

$${( ℒ Q )}_{i}^{( s )} = {Γ}_{ii}^{( s )} Q - β {Γ}_{ii}^{( s )} {p}_{i}^{( s )} ( \frac{{p}_{i}^{( s )}}{m} + 2 η ( {p}_{i}^{( c )} + 2 {p}_{i}^{( s )} - {p}_{i}^{( u )} ) ) Q - β {D}_{ii}^{( s )} ( \frac{1}{m} + 4 η ) Q + {β}^{2} {{D}_{ii}^{( s )} ( \frac{{p}_{i}^{( s )}}{m} + 2 η ( {p}_{i}^{( c )} + 2 {p}_{i}^{( s )} - {p}_{i}^{( u )} ) )}^{2} Q .$$

The i′th term in the sum of [symbol] Q for the clamped chip is given by,

$${( ℒ Q )}_{i}^{( c )} = {Γ}_{ii}^{( c )} Q - β {Γ}_{ii}^{( c )} {p}_{i}^{( c )} ( \frac{{p}_{i}^{( c )}}{m} + 2 η ( {p}_{i}^{( c )} + {p}_{i}^{( s )} ) ) Q - β {D}_{ii}^{( c )} ( \frac{1}{m} + 2 η ) Q + {β}^{2} {D}_{ii}^{( c )} {{β}^{2} ( \frac{{p}_{i}^{( c )}}{m} + 2 η ( {p}_{i}^{( c )} + {p}_{i}^{( s )} ) )}^{2} Q$$

The i′th term in the sum of [symbol] Q for the un-clamped chip is given by,

$${( ℒ Q )}_{i}^{( u )} = {Γ}_{ii}^{( u )} Q - β {Γ}_{ii}^{( u )} {p}_{i}^{( u )} ( \frac{{p}_{i}^{( u )}}{m} + 2 η ( {p}_{i}^{( u )} - {p}_{i}^{( s )} ) ) Q - β {D}_{ii}^{( c )} ( \frac{1}{m} + 2 η ) Q + {β}^{2} {D}_{ii}^{( u )} {{β}^{2} ( \frac{{p}_{i}^{( u )}}{m} + 2 η ( {p}_{i}^{( u )} - {p}_{i}^{( s )} ) )}^{2} Q$$

Now as in the standard Langevin equation, Γᵢᵢ^{(u)}=Γᵢᵢ^{(c)}=Γᵢᵢ^{(s)}=, and Dᵢᵢ^{(c)}=Dᵢᵢ^{(s)}=Dᵢᵢ^{(u)}=D are set. Lastly, if n is large, this gives pᵢ^{(c)}≈−pᵢ^{(s)} and pᵢ^{(u)}≈pᵢ^{(s)}. In this case, the Fokker-Plank operators simplify to,

$${( ℒ Q )}_{i}^{( s )} = γ Q - β γ \frac{{( {p}_{i}^{( s )} )}^{2}}{m} Q - β D ( \frac{1}{m} + 2 η ) Q + {β}^{2} D \frac{{( {p}_{i}^{( s )} )}^{2}}{{m}^{2}}$$

$${( ℒ Q )}_{i}^{( c )} = γ Q - βγ \frac{{( {p}_{i}^{( c )} )}^{2}}{m} Q - β D ( \frac{1}{m} + 2 η ) Q + {β}^{2} D \frac{{( {p}_{i}^{( c )} )}^{2}}{{m}^{2}}$$

$${( ℒ Q )}_{i}^{( u )} = γ Q - β γ \frac{{( {p}_{i}^{( u )} )}^{2}}{m} Q - β D ( \frac{1}{m} + 2 η ) Q + {β}^{2} D \frac{{( {p}_{i}^{( u )} )}^{2}}{{m}^{2}} .$$

Now looking at the first equation, it can be re-written as,

$${( ℒ Q )}_{i}^{( s )} = ( γ - β D ( \frac{1}{m} + 2 η ) + \frac{{( {p}_{i}^{( s )} )}^{2}}{m} ( \frac{{β}^{2} D}{m} - βγ ) ) Q .$$

For this to be zero, the term proportional to

$${( {p}_{i}^{( s )} )}^{2}$$

requires that

$$γ = \frac{β D}{m} .$$

But then,

$${( ℒ Q )}_{i}^{( s )} = - 2 β D η .$$

Furthermore, it is not possible to get this to be zero even if non-diagonal matrix elements are added to D. As such, the position degrees of freedom for qᵢ^{(s)} under a Hamiltonian are not sampled from the Gibbs distribution. This is desired since they are to be sampled from the posterior.

The calculations leading to the above equation assumed that the noise and friction terms were non-diagonal. Since the result is non-zero, general noise and friction matrices are considered. Taking into account all of the cross-terms, the following expression should be zero,

$$0 = ( {Γ}_{{i}^{( s )} {i}^{( s )}} + {Γ}_{{i}^{( c )} {i}^{( c )}} + {Γ}_{{i}^{( u )} {i}^{( u )}} ) Q + {Γ}_{{i}^{( s )} {i}^{( s )}} {p}_{i}^{( s )} \frac{\partial Q}{\partial {p}_{i}^{( s )}} + {Γ}_{{i}^{( c )} {i}^{( c )}} {p}_{i}^{( c )} \frac{\partial Q}{\partial {p}_{i}^{( c )}} + {Γ}_{{i}^{( u )} {i}^{( u )}} {p}_{i}^{( u )} \frac{\partial Q}{\partial {p}_{i}^{( u )}} + {( {{D}^{\frac{1}{2}} ( {D}^{\frac{1}{2}} )}^{T} )}_{{i}^{( s )} {i}^{( s )}} \frac{{\partial }^{2} Q}{\partial {( {p}_{i}^{( s )} )}^{2}} + {( {{D}^{\frac{1}{2}} ( {D}^{\frac{1}{2}} )}^{T} )}_{{i}^{( c )} {i}^{( c )}} \frac{{\partial }^{2} Q}{\partial {( {p}_{i}^{( c )} )}^{2}} + {( {{D}^{\frac{1}{2}} ( {D}^{\frac{1}{2}} )}^{T} )}_{{i}^{( u )} {i}^{( u )}} \frac{{\partial }^{2} Q}{\partial {( {p}_{i}^{( u )} )}^{2}} + {( {{D}^{\frac{1}{2}} ( {D}^{\frac{1}{2}} )}^{T} )}_{{i}^{( s )} {i}^{( c )}} \frac{{\partial }^{2} Q}{\partial {p}_{i}^{( s )} {p}_{i}^{( c )}} + {( {{D}^{\frac{1}{2}} ( {D}^{\frac{1}{2}} )}^{T} )}_{{i}^{( c )} {i}^{( s )}} \frac{{\partial }^{2} Q}{\partial {p}_{i}^{( c )} {p}_{i}^{( s )}} + {( {{D}^{\frac{1}{2}} ( {D}^{\frac{1}{2}} )}^{T} )}_{{i}^{( s )} {i}^{( u )}} \frac{{\partial }^{2} Q}{\partial {p}_{i}^{( s )} {p}_{i}^{( u )}} + {( {{D}^{\frac{1}{2}} ( {D}^{\frac{1}{2}} )}^{T} )}_{{i}^{( u )} {i}^{( s )}} \frac{{\partial }^{2} Q}{\partial {p}_{i}^{( u )} {p}_{i}^{( s )}} + {Γ}_{{i}^{( s )} {i}^{( c )}} {p}_{i}^{( s )} \frac{\partial Q}{\partial {p}_{i}^{( c )}} + {Γ}_{{i}^{( c )} {i}^{( s )}} {p}_{i}^{( c )} \frac{\partial Q}{\partial {p}_{i}^{( s )}} + {Γ}_{{i}^{( s )} {i}^{( u )}} {p}_{i}^{( s )} \frac{\partial Q}{\partial {p}_{i}^{( u )}} + {Γ}_{{i}^{( u )} {i}^{( s )}} {p}_{i}^{( u )} \frac{\partial Q}{\partial {p}_{i}^{( s )}} .$$

Assuming a large η value, it gives that.

$$0 = ( {Γ}_{{i}^{( s )} {i}^{( s )}} + {Γ}_{{i}^{( c )} {i}^{( c )}} + {Γ}_{{i}^{( u )} {i}^{( u )}} ) - β \frac{{( {p}_{i}^{( s )} )}^{2}}{m} ( {Γ}_{{i}^{( s )} {i}^{( s )}} + {Γ}_{{i}^{( c )} {i}^{( c )}} + {Γ}_{{i}^{( u )} {i}^{( u )}} + {Γ}_{{i}^{( s )} {i}^{( u )}} + {Γ}_{{i}^{( u )} {i}^{( s )}} - {Γ}_{{i}^{( s )} {i}^{( c )}} - {Γ}_{{i}^{( c )} {i}^{( s )}} ) + {( {{D}^{\frac{1}{2}} ( {D}^{\frac{1}{2}} )}^{T} )}_{{i}^{( s )} {i}^{( s )}} ( - β ( \frac{1}{m} + 4 η ) + {β}^{2} \frac{{( {p}_{i}^{( s )} )}^{2}}{{m}^{2}} ) + {( {{D}^{\frac{1}{2}} ( {D}^{\frac{1}{2}} )}^{T} )}_{{i}^{( c )} {i}^{( c )}} ( - β ( \frac{1}{m} + 2 η ) + {β}^{2} \frac{{( {p}_{i}^{( s )} )}^{2}}{{m}^{2}} ) + {( {{D}^{\frac{1}{2}} ( {D}^{\frac{1}{2}} )}^{T} )}_{{i}^{( s )} {i}^{( s )}} ( - β ( \frac{1}{m} + 2 η ) + {β}^{2} \frac{{( {p}_{i}^{( s )} )}^{2}}{{m}^{2}} ) + ( - 2 β η - {β}^{2} \frac{{( {p}_{i}^{( s )} )}^{2}}{{m}^{2}} ) ( {( {{D}^{\frac{1}{2}} ( {D}^{\frac{1}{2}} )}^{T} )}_{{i}^{( c )} {i}^{( s )}} + {( {{D}^{\frac{1}{2}} ( {D}^{\frac{1}{2}} )}^{T} )}_{{i}^{( s )} {i}^{( c )}} ) + ( 2 β η + {β}^{2} \frac{{( {p}_{i}^{( s )} )}^{2}}{{m}^{2}} ) ( {( {{D}^{\frac{1}{2}} ( {D}^{\frac{1}{2}} )}^{T} )}_{{i}^{( u )} {i}^{( s )}} + {( {{D}^{\frac{1}{2}} ( {D}^{\frac{1}{2}} )}^{T} )}_{{i}^{( s )} {i}^{( u )}} ) .$$

To simplify the notation, a term like

$${( {{D}^{\frac{1}{2}} ( {D}^{\frac{1}{2}} )}^{T} )}_{{i}^{( s )} {i}^{( u )}}$$

is re-written as Dₛᵤ and so on. Next, require that the term proportional to

$$\frac{{( {p}_{i}^{( s )} )}^{2}}{m}$$

be,

$$- β ( {Γ}_{{i}^{( s )} {i}^{( s )}} + {Γ}_{{i}^{( c )} {i}^{( c )}} + {Γ}_{{i}^{( u )} {i}^{( u )}} + {Γ}_{{i}^{( s )} {i}^{( u )}} + {Γ}_{{i}^{( u )} {i}^{( s )}} - {Γ}_{{i}^{( s )} {i}^{( c )}} - {Γ}_{{i}^{( c )} {i}^{( s )}} ) + \frac{{β}^{2}}{m} ( {D}_{ss} + {D}_{cc} + {D}_{uu} - {D}_{cs} - {D}_{sc} + {D}_{us} + {D}_{su} ) = 0 , and ,$$

$$( {Γ}_{{i}^{( s )} {i}^{( s )}} + {Γ}_{{i}^{( c )} {i}^{( c )}} + {Γ}_{{i}^{( u )} {i}^{( u )}} ) - β ( \frac{1}{m} + 4 η ) {D}_{ss} - β ( \frac{1}{m} + 2 η ) ( {D}_{cc} + {D}_{uu} ) - 2 βη ( {D}_{cs} + {D}_{sc} ) + 2 β η ( {D}_{su} + {D}_{us} ) = 0.$$

If it is assumed that Γ is diagonal, it can be required that,

$${D}_{cc} = \frac{m}{β ( 1 + 4 m η )} ( {Γ}_{cc} + {Γ}_{ss} + {Γ}_{uu} + 2 m η ( {Γ}_{cc} + {Γ}_{ss} + {Γ}_{uu} ) ) - \frac{1 + 6 m η}{1 + 4 m η} {D}_{ss} - {D}_{uu}$$

$${D}_{su} = {D}_{cs} + {D}_{sc} - {D}_{us} + \frac{2 m η}{1 + 4 m η} {D}_{ss} + \frac{2 {m}^{2} η}{β ( 1 + 4 m η )} ( {Γ}_{cc} + {Γ}_{ss} + {Γ}_{uu} ) .$$

When mη>>1, the above simplifies to,

$${D}_{cc} \approx \frac{m}{2 β} ( {Γ}_{cc} + {Γ}_{ss} + {Γ}_{uu} ) - \frac{3}{2} {D}_{ss} - {D}_{uu}$$

$${D}_{su} \approx {D}_{cs} + {D}_{sc} - {D}_{us} + \frac{{D}_{ss}}{2} + \frac{m}{2 β} ( {Γ}_{cc} + {Γ}_{ss} + {Γ}_{uu} ) .$$

Keeping in mind the above mathematical proofs of the self-learning nature of the neuro-thermodynamic computers described herein, the next section further describes how such neuro-thermodynamic computers are used to perform machine learning training and inference.

For example, FIGS. 7A-7C illustrate example embodiments of posterior predictive inference and meta-learning techniques using architectures for self-learning neuro-thermodynamic computers described herein, according to some embodiments.

As an example, values of training dataset 700 may be clamped to neurons 702, 704, 706, and 708 of clamped chip 104. For example, neuron 702 may be clamped to a value of 0, neuron 704 may be clamped to a value of 1, neuron 706 may be clamped to a value of 1 and neuron 708 may be clamped to a value of 0. The self-learning neuro-thermodynamic computing device 102 may then be allowed to evolve according to Langevin dynamics such that weights and biases associated with neurons 702, 704, 706, and 708 are learned, such as the weights 504 and biases 502 shown for neurons 254 in FIG. 5.

Once the weights and biases are learned, they may be held constant, or allowed to evolve, and new data (e.g. test dataset 720) may be clamped to at least some of the neurons, while others remained un-clamped and are used to generate inference values. For example, neuron 704 may be clamped to have a value of 0 and neuron 706 may be clamped to have a value of 0. Also, neurons 702 and 708 may be un-clamped and may be used to generate inferences.

With the weights and biases learned and the test data clamped to some of the neurons, the self-learning neuro-thermodynamic computing device 102 may then be allowed to evolve according to Langevin dynamic such that values of the un-clamped neurons are updated. The un-clamped neurons, may be measured (e.g. measured outputs for interface 740) to determine inference values, such as that neuron 702 has an inference value of 1 and neuron 708 has an inference value of 1.

After training an energy based model using the dynamics and architecture described, if the position coupling strengths (mediated by the A parameters) are large enough such that the weights and biases are nearly identical on the server, clamped and un-clamped chips, inference can be performed using the clamped chip as follows. First the weights and biases on the clamped chip are clamped such that they remain stationary through time. Inference is then performed by clamping the visible nodes of the clamped chip to a new data point given in the test set, and letting the visible neurons of the clamped chip evolve following Langevin dynamics such as described herein. After some time T, the visible neurons of the clamped chip are then measured to read out their values. Alternatively, values (either sample values or expectation values) may be transferred, for example as inputs into another energy-based model, without necessarily requiring measurement. The required evolution time may be determined from simulations given the hyperparameter configuration of the system, and the particular energy-based model used to obtain the trained weights and biases. Alternatively, online learning can be performed if clamping the weights during the training phase is omitted, as the system will continue to learn during inference.

Several techniques can be used to clamp the weights and biases of the clamped chip prior to performing inference. One method would be to simply increase the masses of the weights and biases of the clamped chip such that they remain nearly stationary during inference. Alternatively, if the server or un-clamped chip are coupled to an auxiliary system which allows their weights and biases to be measured, a time average measurement of the weights and biases could be performed. Such a measurement would allow one to obtain the statistics (mean and covariance) of the weights and biases. The parameters \tilde{φ}_{L}^{(w)} and \tilde{φ}_{L}^{(b)} in a Hamiltonian could be tuned to the mean obtained from the time average measurements, along with increasing E_{L}^{(w)} and E_{L}^{(b)} to ensure strong clamping. In particular, the architecture described herein generates weights and biases which are approximate samples from the Bayesian posterior of the parameters. In other words, through stochastic gradient Langevin dynamics, weights and biases θ are obtained which are samples from p(θ| [symbol] ) for some data set [symbol] . Suppose now there is a data [symbol] ={x,y} where x is known, and y is unknown (where [symbol] can be encoded using the visible neurons of the three-chip architecture). The unknown visible neurons y can be sampled from,

$$y ∼ p ( y \vert 𝒟 , x ) = \int d θ p ( y \vert θ , x ) p ( θ \vert 𝒟 ) ,$$

where in computing p(y|θ,x), visible neurons are partially such that some of the visible neurons are clamped to the known data x for a given set of parameters θ while other visible neurons corresponding to values to be inferred are left un-clamped. Furthermore, consider the case where there is no data clamping, so that the data is simply [symbol] =y for some unknown y. In this case, sampling can be performed from the posterior predictive distribution for generative modeling using the trained weights as,

$$y ∼ p ( y \vert 𝒟 ) = \int d θ p ( y \vert θ ) p ( θ \vert 𝒟 ) .$$

A person having ordinary skill in the art should understand that FIGS. 7A-7C, and FIGS. 8A-8C described below, illustrate embodiments in which self-learning neuro-thermodynamic computing device 102 is implemented as a three-chip architecture (see also FIG. 1 described herein) including a server chip. Similar example illustrations, however, may be understood using a two-chip architecture (see also FIG. 10 herein), without a server chip, and are encompassed by the description herein. Also, as shown in FIG. 9 more than three chips may be used.

Next, consider a Hamiltonian with the position and momentum coupling terms. At thermal equilibrium, the Boltzmann distribution is given by,

$$P ( q , p ) = \frac{{e}^{- β {H}_{tot}}}{Z} ,$$

where Z=∫e^{-βH}^{ₜₒₜ}dq dp and β=1/(k_{B}T). Now, consider the position and momentum degrees of freedom for the synapses. If a very large position coupling strength λ=λ₁=λ₂ is assumed as compared to the other coupling parameters, the Boltzmann distribution simplifies to,

$$P ( {q}_{k}^{( s )} , {q}_{k}^{( c )} , {q}_{k}^{( u )} , {p}_{k}^{( s )} , {p}_{k}^{( c )} , {p}_{k}^{( u )} ) \approx exp ( - β ( \frac{{( {p}_{k}^{( s )} )}^{2}}{2 {m}_{k}^{( s )}} + \frac{{( {p}_{k}^{( c )} )}^{2}}{2 {m}_{k}^{( c )}} + \frac{{( {p}_{k}^{( u )} )}^{2}}{2 {m}_{k}^{( u )}} + {λ ( {q}_{k}^{( c )} - {q}_{k}^{( s )} )}^{2} + {λ ( {q}_{k}^{( u )} - {q}_{k}^{( s )} )}^{2} ) ) / Z$$

Using the Boltzmann distribution, the expectation values for the position degrees of freedom are given by,

$$\begin{matrix}〈 {q}_{k}^{( c )} 〉 = \int {q}_{k}^{( c )} P ( {q}_{k}^{( s )} , {q}_{k}^{( c )} , {q}_{k}^{( u )} , {p}_{k}^{( s )} , {p}_{k}^{( c )} , {p}_{k}^{( u )} ) \\ d {q}_{k}^{( c )} , d {q}_{k}^{( s )} , d {q}_{k}^{( u )} , d {p}_{k}^{( c )} , d {p}_{k}^{( s )} , d {p}_{k}^{( u )} \\ = \int \frac{{q}_{k}^{( s )}}{\int {Z}_{s} d {q}_{k}^{( s )}} d {q}_{k}^{( s )} ≡ {I}_{s} ,\end{matrix}$$

where the following is defined,

$$\begin{matrix}{Z}_{s} ≡ \int P ( {q}_{k}^{( s )} , {q}_{k}^{( c )} , {q}_{k}^{( u )} , {p}_{k}^{( s )} , {p}_{k}^{( c )} , {p}_{k}^{( u )} ) \\ d {q}_{k}^{( c )} , d {q}_{k}^{( u )} , d {p}_{k}^{( s )} , d {p}_{k}^{( c )} , d {p}_{k}^{( u )} \\ = \frac{2 \sqrt{2 {m}_{k}^{( s )}} {m}_{k}^{( c )} {π}^{5 / 2}}{λ {β}^{5 / 2}} .\end{matrix}$$

Note also that Zₛ=Zᵤ=Z_{c}. Similarly, note that [symbol] qₖ^{(u)} [symbol] =Iₛ and [symbol] qₖ^{(s)} [symbol] =Iᵤ=I_{c}. It is straightforward to evaluate the integrals to show that I_{c}=Iₛ=Iᵤ=0. As such, it can be seen that a strong position coupling term forces the position degrees of freedom of the server, clamped and un-clamped chip to be strongly correlated. Alternatively, the system could also operate in the low temperature regime, which would force the expectation values of the position operators to be close to zero. In such a setting, the temperature could then quickly be increased right before starting the time evolution described for the self-learning algorithm described herein. Lastly, analogous calculations can be performed to show that the expectation values of the momentum operators are also zero in this regime.

FIGS. 8A-8C illustrate other example embodiments of posterior predictive inference and meta-learning techniques using architectures for self-learning neuro-thermodynamic computers described herein, wherein inferences are generated for missing data in the test-set data, according to some embodiments.

FIGS. 8A-8C illustrate a similar process as FIGS. 7A-7C. However, in the example shown in FIGS. 8A-8C the training data and the test data may be combined. For example, there may be some un-known values in the training data set that are to be inferred. For example, neurons 802, 804, 806, and 810 have values that are clamped to the combined training and test dataset 800. However, neurons 808 and 812 are left un-clamped. After a 1^{st} evolution 820 weights and biases are learned. Then further evolution is performed (830) using the learned weights and biases and the neurons with values to be inferred are measured (840) to generate the inference values.

As shown, a training algorithm such as shown herein can be combined along with the inference protocols in order to implement a meta-learning scheme for the hyperparameters of a three-chip architecture. After training the system, the accuracy can be computed by performing inference on a validation set. Such a protocol can be repeated, with a different hyperparameter configuration until the desired validation accuracy is achieved. An FPGA or other classical device, such as classical computing device 114 shown in FIG. 1, can be used during the meta-learning algorithm. The role of the FPGA is to find new hyperparameters after each training/inference step. For instance, a Bayesian black box optimizer algorithm for hyperparameter tuning may be used, in addition to hyperparameter gradient estimators. An illustration of a meta-learning protocol is shown in FIG. 10.

FIG. 9 illustrates an example hardware implementation of a given multi-chip architecture of a self-learning thermodynamic computer, according to some embodiments.

In some embodiments, multiple clamped and un-clamped chips may be coupled, respectively, to a single server chip, such as un-clamped chips 902, 904, and 906 and clamped chips 910, 912, and 914, which are coupled to server chip 908. As shown via the dashed vs dotted lines in FIG. 9, position and momentum couplings may define interactions between respective clamped and un-clamped chips and the server chip, and such three-dimensional stacked architectural layout designs may promote data parallelization.

A person having ordinary skill in the art should understand that FIG. 9 may demonstrate embodiments of a given multi-chip architecture in which three clamped chips and three un-clamped chips are coupled to a single server chip. However, such embodiments are not meant to be restrictive, and more/less clamped and un-clamped chips that are coupled to a single server chip may still be encompassed in the description herein.

In a Welling and Teh update rule such as shown above, it can be seen that one can choose a mini-batch of size n≤N in order to compute the gradients over a subset of the full data set. In FIG. 9, it is illustrated how a mini-batch of size greater than one can be achieved using multiple clamped chips. Each clamped chip has the visible neurons clamped to a unique training data point, and the coupling between a given clamped chip to the server chip is given using the same position and momentum coupling terms as in the Hamiltonians described above, such as Hₜₒₜ, although the size of the coupling terms is re-scaled by 1/n in order to achieve an equation of motion analogous to a parameter update rule such as shown above. As such, additional clamped chips may be used to accelerate training a given energy-based model by allowing for mini-batch sizes which are greater than one.

In addition to having multiple clamped chips coupled to the server chip, it is also possible to have multiple un-clamped chips coupled to the server chip using the same coupling terms as described in the above discussed Hamiltonians, such as Hₜₒₜ. Having multiple un-clamped chips coupled to the server chip in parallel could allow for a space average to be used instead of the time average

$${E}_{δ t} [ \frac{\partial {H}_{tot}}{\partial {q}_{k}^{( u )}} {\vert}_{t} ] .$$

By space average, there would instead be an approximation to,

$${E}_{x ∼ {p}_{θ ( x )}} [ \frac{\partial {H}_{tot}}{\partial {q}_{k}^{( u )}} ( x , θ ) {\vert}_{t} ] \approx {\sum }_{{x}^{′}} \frac{\partial {H}_{tot}}{\partial {q}_{k}^{( u )}} ( {x}^{′} , θ ) {\vert}_{t} ,$$

where x is the set of all visible neurons, and θ represents the set of all weights and biases. The sum in the space average is over visible neurons x′ sampled from each of the un-clamped chips. In such a setting, the space average may be used in the unclamped and server position degree of freedom instead of

$${E}_{δ t} [ \frac{\partial {H}_{tot}}{\partial {q}_{k}^{( u )}} {\vert}_{t} ] .$$

In some embodiments, architectures may be generalized to include hidden neurons. Hidden neurons may be added to the network, and coupled to other nodes of the network using weights, in the same way coupling terms were used for the fully visible network. In particular, for a given chip (either clamped or un-clamped), generalize the Hamiltonian in (e.g. H) to include hidden neurons as follows:

$${H}_{total} = {\sum }_{j ∈ {V}_{vis}} ( \frac{{p}_{{n}_{j}}^{2}}{2 {m}_{{n}_{j}}^{( v )}} + {{E}_{L}^{( v )} ( {φ}_{{n}_{j}} - {\tilde{φ}}_{L}^{( v )} )}^{2} + {E}_{J 0}^{( v )} cos ( {\tilde{φ}}_{DC}^{( v )} / 2 ) ( 1 - cos ( {φ}_{{n}_{j}} ) ) ) + {\sum }_{j ∈ {V}_{hid}} ( \frac{{p}_{{n}_{j}}^{2}}{2 {m}_{{n}_{j}}^{( h )}} + {{E}_{L}^{( h )} ( {φ}_{{n}_{j}} - {\tilde{φ}}_{L}^{( h )} )}^{2} + {E}_{J 0}^{( h )} cos ( {\tilde{φ}}_{DC}^{( h )} / 2 ) ( 1 - cos ( {φ}_{{n}_{j}} ) ) ) + {\sum }_{k , l ∈ ℰ} ( \frac{{p}_{{s}_{j}}^{2}}{2 {m}_{{s}_{k , l}}^{( w )}} + {{E}_{L}^{( w )} ( {φ}_{{s}_{k , l}} - {\tilde{φ}}_{L}^{( w )} )}^{2} + {E}_{J 0}^{( w )} cos ( {\tilde{φ}}_{DC}^{( w )} / 2 ) ( 1 - cos ( {φ}_{{s}_{k , l}} ) ) ) + {\sum }_{j ∈ V} ( \frac{{p}_{{b}_{j}}^{2}}{2 {m}_{{b}_{j}}^{( b )}} + {{E}_{L}^{( b )} ( {φ}_{{b}_{j}} - {\tilde{φ}}_{L}^{( b )} )}^{2} + {E}_{J 0}^{( b )} cos ( {\tilde{φ}}_{DC}^{( b )} / 2 ) ( 1 - cos ( {φ}_{{b}_{j}} ) ) ) + ( α {\sum }_{\{ k , l \} ∈ ℰ} {φ}_{{s}_{kl}} {φ}_{{n}_{k}} {φ}_{{n}_{l}} + β {\sum }_{j ∈ V} {φ}_{{n}_{j}} {φ}_{{b}_{j}} ) ,$$

where the set of all visible and hidden neurons is partitioned as [symbol] = [symbol] ∪ [symbol] . The hidden neurons may have different potential wells and masses relative to the visible neurons. The coupling terms between clamped, un-clamped and server chips are identical to those described in previous sections.

For the clamped chip, the hidden neurons evolve freely, with the visible neurons being clamped to some data set. The goal is to obtain gradients which are averaged over samples from the distribution p_{θ}(z|x_{c}) for a given set of parameters θ (the visible nodes clamped to the data are denoted as x_{c}). Similarly to an approximate time average, the gradient steps taken on the clamped chip can be approximated by a time average as follows,

$${E}_{δ t}^{( z )} [ \frac{\partial {H}_{tot}}{\partial {q}_{k}^{( c )}} {\vert}_{t} ] \approx \frac{1}{δ t} {\int }_{t}^{t + δ t} \frac{\partial {H}_{tot} ( {x}_{c} , z ( τ ) )}{\partial {q}_{k}^{( c )}} d τ ,$$

where the superscript (z) are added to indicate that the hidden neurons are un-clamped during the time evolution of size δt.

For the un-clamped chip, both the visible and hidden neurons are un-clamped and thus evolve freely. The goal is to obtain gradients which are averaged over samples from the joint distribution p_{θ}(x,z) for a given set of parameters θ. Since both the visible and hidden neurons evolve over some time δt, the gradient updates may be approximated as

$${E}_{δ t}^{( x , z )} [ \frac{\partial {H}_{tot}}{\partial {q}_{k}^{( u )}} {\vert}_{t} ] \approx \frac{1}{δ t} {\int }_{t}^{t + δ t} \frac{\partial {H}_{tot} ( x ( τ ) , z ( τ ) )}{\partial {q}_{k}^{( u )}} d τ ,$$

where the superscript (x,z) are added to indicate that both the visible and hidden neurons are un-clamped during the evolution.

In some embodiments, a Euler-Maruyama method for a self-learning architecture described above using the server chip may be used. Consider the following initial conditions: qₓ^{(c)}(0)=qₖ^{(u)}(0)=qₖ^{(s)}(0)=q₀, and pₖ^{(c)}(0)=pₖ^{(u)}(0)=pₖ^{(s)}(0)=0. Note that the labels “(u)”, “(c)” and “(s)” are used to represent the un-clamped, clamped and server degrees of freedom. In what follows, the following noise terms are defined as,

$${N}_{k}^{( s )} ( t + δ t ) = \sqrt{2 {m}_{k}^{( s )} γ {k}_{B} T} {ξ}_{t}$$

$${N}_{k}^{( c )} ( t + δ t ) = \sqrt{2 {m}_{k}^{( c )} γ {k}_{B} T} {ξ}_{t}$$

$${N}_{k}^{( u )} ( t + δ t ) = \sqrt{2 {m}_{k}^{( u )} γ {k}_{B} T} {ξ}_{t} ,$$

where ξₜ˜N(0,δt). Using the structure of Hₜₒₜ, the update equations for the position and momentum of the three chips can be written as follows,

$${q}_{k}^{( s )} ( t + δ t ) = {q}^{( s )} ( t ) + \frac{δ t}{{m}_{k}^{( s )}} {p}_{k}^{( s )} ( t ) + 2 δ t [ {η}_{1} ( {p}_{k}^{( c )} ( t ) + {p}_{k}^{( s )} ( t ) ) - {η}_{2} ( {p}_{k}^{( u )} ( t ) + {p}_{k}^{( s )} ( t ) ) ]$$

$${p}_{k}^{( s )} ( t + δ t ) = ( 1 - γ δ t ) {p}_{k}^{( s )} ( t ) + 2 δ t [ {λ}_{t} ( {q}_{k}^{( c )} ( t ) - {q}_{k}^{( s )} ( t ) ) + {λ}_{2} ( {q}_{k}^{( u )} ( t ) - {q}_{k}^{( s )} ( t ) ) ] + {N}_{k}^{( s )} ( δ t )$$

$${q}_{k}^{( u )} ( t + δ t ) = {q}_{k}^{( u )} ( t ) + δ t [ \frac{{p}_{k}^{( u )} ( t )}{{m}_{k}^{( u )}} + 2 {η}_{2} ( {p}_{k}^{( u )} ( t ) - {p}_{k}^{( s )} ( t ) ) ]$$

$${p}_{k}^{( u )} ( t + δ t ) = ( 1 - γ δ t ) {p}_{k}^{( u )} ( t ) - δ t [ {E}_{δ t} [ \frac{\partial {H}_{u}}{\partial {q}_{k}^{( u )}} {\vert}_{t} ] + 2 {λ}_{2} ( {q}_{k}^{( u )} ( t ) - {q}_{k}^{( s )} ( t ) ) ] + {N}_{k}^{( u )} ( δ t )$$

$${q}_{k}^{( c )} ( t + δ t ) = {q}_{k}^{( c )} ( t ) + δ t [ \frac{{p}_{k}^{( c )} ( t )}{{m}_{k}^{( c )}} + 2 {η}_{1} ( {p}_{k}^{( c )} ( t ) - {p}_{k}^{( s )} ( t ) ) ]$$

$${p}_{k}^{( c )} ( t + δ t ) = ( 1 - γ δ t ) {p}_{k}^{( c )} ( t ) - δ t [ \frac{\partial {H}_{c}}{\partial {q}_{k}^{( c )}} {\vert}_{t} ] + 2 {λ}_{1} ( {q}_{k}^{( c )} ( t ) - {q}_{k}^{( s )} ( t ) ) ] + {N}_{k}^{( c )} ( δ t ) .$$

Next, solution are given to the time evolution of the synapse degrees of freedom for several increments of time δt, starting at time t=0.

$$Evolve for time δ t .$$

$${q}_{k}^{( s )} ( δ t ) = {q}_{0}$$

$${p}_{k}^{( s )} ( δ t ) = {N}_{k}^{( s )} ( δ t )$$

$${q}_{k}^{( u )} ( δ t ) = {q}_{0}$$

$${p}_{k}^{( u )} ( δ t ) = - δ t {E}_{δ t} [ \frac{\partial {H}_{u}}{\partial {q}_{k}^{( u )}} {\vert}_{0} ] + {N}_{k}^{( u )} ( δ t )$$

$${q}_{k}^{( c )} ( δ t ) = {q}_{0}$$

$${p}_{k}^{( c )} ( δ t ) = - δ t \frac{\partial {H}_{c}}{\partial {q}_{k}^{( c )}} {\vert}_{0} + {N}_{k}^{( c )} ( δ t )$$

$$Evolve for time 2 δ t .$$

$${q}_{k}^{( s )} ( 2 δ t ) = {q}_{0} - 2 {( δ t )}^{2} ( {η}_{1} \frac{\partial {H}_{c}}{\partial {q}_{k}^{( c )}} {\vert}_{0} - {η}_{2} {E}_{δ t} [ \frac{\partial {H}_{u}}{\partial {q}_{k}^{( u )}} {\vert}_{0} ] ) + δ t ( ( \frac{1}{{m}_{k}^{( s )}} + 2 ( {η}_{1} + {η}_{2} ) ) {N}_{k}^{( s )} ( δ t ) + 2 ( {η}_{1} {N}_{k}^{( c )} ( δ t ) - {η}_{2} {N}_{k}^{( u )} ( δ t ) ) )$$

$${p}_{k}^{( s )} ( 2 δ t ) = ( 1 - γ δ t ) {N}_{k}^{( s )} ( δ t ) + {N}_{k}^{( s )} ( 2 δ t )$$

$${q}_{k}^{( u )} ( 2 δ t ) = {q}_{0} - {( δ t )}^{2} ( 2 {η}_{2} + \frac{1}{{m}_{k}^{( u )}} ) {E}_{δ t} [ \frac{\partial {H}_{u}}{\partial {q}_{k}^{( u )}} {\vert}_{0} ] + δ t ( ( 2 {η}_{2} + \frac{1}{{m}_{k}^{( u )}} ) {N}_{k}^{( u )} ( δ t ) - 2 {η}_{2} {N}_{k}^{( s )} ( δ t ) )$$

$${p}_{k}^{( u )} ( 2 δ t ) = - δ t ( ( 1 - γ δ t ) {E}_{δ t} [ \frac{\partial {H}_{u}}{\partial {q}_{k}^{( u )}} {\vert}_{0} ] + {E}_{δ t} [ \frac{\partial {H}_{u}}{\partial {q}_{k}^{( u )}} {\vert}_{δ t} ] ) + ( 1 - γ δ t ) {N}_{k}^{( u )} ( δ t ) + {N}_{k}^{( u )} ( 2 δ t )$$

$${q}_{k}^{( c )} ( 2 δ t ) = {q}_{0} - {( δ t )}^{2} ( 2 {η}_{1} + \frac{1}{{m}_{k}^{( c )}} ) \frac{\partial {H}_{c}}{\partial {q}_{k}^{( c )}} {\vert}_{0} + δ t ( ( 2 {η}_{1} + \frac{1}{{m}_{k}^{( c )}} ) {N}_{k}^{( c )} ( δ t ) - 2 {η}_{1} {N}_{k}^{( s )} ( δ t ) )$$

$${p}_{k}^{( c )} ( 2 δ t ) = - δ t ( ( 1 - γ δ t ) \frac{\partial {H}_{c}}{\partial {q}_{k}^{( c )}} {\vert}_{0} + \frac{\partial {H}_{c}}{\partial {q}_{k}^{( c )}} {\vert}_{δ t} ) + ( 1 - γ δ t ) {N}_{k}^{( c )} ( δ t ) + {N}_{k}^{( c )} ( 2 δ t ) .$$

At this stage, note that qₖ^{(s)}(3δt) has the correct form if it is assumed γδt≈1. Since δt must be small, values in the large γ limit (also known as the overdamped limit) are used. In what follows, it is assumed that the system is in a regime where such a condition is satisfied and thus all terms proportional to (1−γδt) are removed.
Evolve for time 3 δt

$${q}_{k}^{( s )} ( 3 δ t ) = {q}_{k}^{( s )} ( 2 δ t ) - 2 {( δ t )}^{2} ( {η}_{1} \frac{\partial {H}_{c}}{\partial {q}_{k}^{( c )}} {\vert}_{δ t} - {η}_{2 {E}_{δ t}} [ \frac{\partial {H}_{u}}{\partial {q}_{k}^{( u )}} {\vert}_{δ t} ] ) + δ t ( ( \frac{1}{{m}_{k}^{( s )}} + 2 ( {η}_{1} + {η}_{2} ) ) {N}_{k}^{( s )} ( 2 δ t ) + 2 ( {η}_{1} {N}_{k}^{( c )} ( 2 δ t ) - {η}_{2} {N}_{k}^{( u )} ( 2 δ t ) ) )$$

$${p}_{k}^{( s )} ( 3 δ t ) = 2 {( δ t )}^{3} \{ {λ}_{2} ( 2 {η}_{1} \frac{\partial {H}_{c}}{\partial {q}_{k}^{( c )}} {\vert}_{0} - ( 4 {η}_{2} + \frac{1}{{m}_{k}^{( u )}} ) {E}_{δ t} [ \frac{\partial {H}_{u}}{\partial {q}_{k}^{( u )}} {\vert}_{0} ] ) - {λ}_{1} ( \frac{1}{{m}_{k}^{( c )}} \frac{\partial {H}_{c}}{\partial {q}_{k}^{( c )}} {\vert}_{0} + 2 {η}_{2} {E}_{δ t} [ \frac{\partial {H}_{u}}{\partial {q}_{k}^{( u )}} {\vert}_{0} ] ) \} + {N}_{k}^{( s )} ( 3 δ t ) .$$

Note that (ignoring the noise term), pₖ^{(s)}(3δt)∝(δt)³, whereas the other non-zero terms above are proportional to (δt)². And, only including the leading order noise term in the expression for pₖ^{(s)}(3δt). In the following analysis, only leading order terms are kept which are proportional to (δt)² for the position degrees of freedom and St for the momentum degrees of freedom.

$${q}_{k}^{( u )} ( 3 δ t ) = {q}_{k}^{( u )} ( 2 δ t ) - {( δ t )}^{2} ( \frac{1}{{m}_{k}^{( u )}} + 2 {η}_{2} ) {E}_{δ t} [ \frac{\partial {H}_{u}}{\partial {q}_{k}^{( u )}} {\vert}_{δ t} ] + δ t ( ( 2 {η}_{2} + \frac{1}{{m}_{k}^{( u )}} ) {N}_{k}^{( u )} ( 2 δ t ) - 2 {η}_{2} {N}_{k}^{( s )} ( 2 δ t ) )$$

$${p}_{k}^{( u )} ( 3 δ t ) = - δ t {E}_{δ t} [ \frac{\partial {H}_{u}}{\partial {q}_{k}^{( u )}} {\vert}_{2 δ t} ] + {N}_{k}^{( u )} ( 3 δ t )$$

$${q}_{k}^{( c )} ( 3 δ t ) = {q}_{k}^{( c )} ( 2 δ t ) - {( δ t )}^{2} ( \frac{1}{{m}_{k}^{( c )}} + 2 {η}_{1} ) \frac{\partial {H}_{c}}{\partial {q}_{k}^{( c )}} {\vert}_{δ t} + δ t ( ( 2 {η}_{1} + \frac{1}{{m}_{k}^{( c )}} ) {N}_{k}^{( c )} ( 2 δ t ) - 2 {η}_{1} {N}_{k}^{( s )} ( 2 δ t ) )$$

$${p}_{k}^{( c )} ( 3 δ t ) = - δ t \frac{\partial {H}_{c}}{\partial {q}_{k}^{( c )}} {\vert}_{2 δ t} + {N}_{k}^{( c )} ( 3 δ t )$$

$$Evolve for time 4 δ t .$$

$${q}_{k}^{( s )} ( 4 δ t ) = {q}_{k}^{( s )} ( 3 δ t ) - 2 {( δ t )}^{2} ( {η}_{1} \frac{\partial {H}_{c}}{\partial {q}_{k}^{( c )}} {\vert}_{2 δ t} - {η}_{2 {E}_{δ t}} [ \frac{\partial {H}_{u}}{\partial {q}_{k}^{( u )}} {\vert}_{2 δ t} ] ) + δ t ( ( \frac{1}{{m}_{k}^{( s )}} + 2 ( {η}_{1} + {η}_{2} ) ) {N}_{k}^{( s )} ( 3 δ t ) + 2 ( {η}_{1} {N}_{k}^{( c )} ( 3 δ t ) - {η}_{2} {N}_{k}^{( u )} ( 3 δ t ) ) )$$

$${p}_{k}^{( s )} ( 4 δ t ) = {N}_{k}^{( s )} ( 4 δ t ) + 𝒪 ( {( δ t )}^{3} ) .$$

As can be shown by recursively applying the Euler-Maruyama update rules, the momentum degrees of freedom for the server chip will continue to be proportional to (δt)³ plus some noise term. As such, the position and momentum variables for the clamped and un-clamped chip will continue to have the same structure as shown above.

As can be seen from the equations above, qₖ^{(s)} has a form analogues to a parameter update rule described herein, albeit with a modified noise term (which includes the sum of Gaussian noise terms). The coupling parameters η₁ and η₂ can be tuned numerically given a particular problem of interest to yield the best results. It is also noted that the terms proportional to λ₁ and λ₂ (e.g., the position coupling terms) only appear at higher orders, and thus appear to have no impact on the lower order equations of motion. However, this is a result of the chosen initial conditions qₖ^{(c)}(0)=qₖ^{(u)}(0)=qₖ^{(s)}(0)=q₀. In order to get such initial conditions, the position couplings terms can be used to force all three chips to take on the same initial values. This can be achieved by using a large value of λ relative to the temperature of the system.

In this section a gate-based approach was provided to implement a self-learning algorithm. Before moving forward, consider weekly second order equations of motion for a physical system undergoing Langevin dynamics. Such equations will be used to describe the system.

The equation of motion for a system of particles governed by some Hamiltonian H undergoing Langevin dynamics is given by,

$${dq}_{k} ( t ) = {m}_{k}^{- 1} {p}_{k} ( t ) dt ,$$

$${dp}_{k} ( t ) = - \frac{\partial H}{\partial {q}_{k}} dt - γ {p}_{k} ( t ) dt + σ {m}_{k}^{1 / 2} {dW}_{t} ,$$

where σ=\sqrt{2k_{b}Tγ}, γ is a friction term and Wₜ is a Weiner process. The k′th position and momentum are written as qₖ and pₖ, with 1≤k≤N for a system of N particles. Using the G-JF method, the equations are given herein.

Now, the core gate used in the learning algorithm is given as,

$$M ( q , p ) {M}^{†} = ( \frac{1}{1 + ϵ} q , - ( 1 + ϵ ) p ) .$$

To keep the equations more compact, the noise terms are omitted. Now, start with the initial conditions q_k(0)=q\hat{ }{(0)}_k and pₖ(0)=0. Also, denote the Hamiltonian during the clamped phase as H_{c} and the Hamiltonian during the un-clamped phase (e.g., when the visible neurons are not clamped to the data) as H_{uc}. Lastly, to make the presentation as concise as possible, consider the evolution steps in the following.
Evolve (clamped phase) for time δt.

$${q}_{k} ( δ t ) = {q}_{k}^{( 0 )} - \frac{{b ( δ t )}^{2}}{2 {m}_{k}} \frac{\partial {H}_{c}}{\partial {q}_{k}} {\vert}_{0}$$

$${p}_{k} ( δ t ) = - \frac{δ t}{2} ( a \frac{\partial {H}_{c}}{\partial {q}_{k}} {\vert}_{0} + \frac{\partial {H}_{c}}{\partial {q}_{k}} {\vert}_{δ t} )$$

Evolve (clamped) for time δt. Un-clamp at time 2 δt.

$${q}_{k} ( 2 δ t ) = {q}_{k}^{( 0 )} - \frac{{b ( δ t )}^{2}}{2 {m}_{k}} ( 1 + a ) \frac{\partial {H}_{c}}{\partial {q}_{k}} {\vert}_{0} - \frac{{b ( δ t )}^{2}}{{m}_{k}} \frac{\partial {H}_{c}}{\partial {q}_{k}} {\vert}_{δ t}$$

$${p}_{k} ( 2 δ t ) = - \frac{{a}^{2} δ t}{2} \frac{\partial {H}_{c}}{\partial {q}_{k}} {\vert}_{0} - a δ t \frac{\partial {H}_{c}}{\partial {q}_{k}} {\vert}_{δ t} - \frac{δ t}{2} \frac{\partial {H}_{uc}}{\partial {q}_{k}} {\vert}_{2 δ t}$$

Apply M gate

$${\tilde{q}}_{k} ( 2 δ t ) = \frac{{q}_{k}^{( 0 )}}{1 + ϵ} - \frac{{b ( δ t )}^{2}}{2 {m}_{k}} \frac{( 1 + a )}{1 + ϵ} \frac{\partial {H}_{c}}{\partial {q}_{k}} {\vert}_{0} - \frac{{b ( δ t )}^{2}}{{m}_{k} ( 1 + ϵ )} \frac{\partial {H}_{c}}{\partial {q}_{k}} {\vert}_{δ t}$$

$${\tilde{p}}_{k} ( 2 δ t ) = - \frac{( 1 + ϵ ) {a}^{2} δ t}{2} \frac{\partial {H}_{c}}{\partial {q}_{k}} {\vert}_{0} + ( 1 + ϵ ) a δ t \frac{\partial {H}_{c}}{\partial {q}_{k}} {\vert}_{δ t} - \frac{( 1 + ϵ ) δ t}{2} \frac{\partial {H}_{uc}}{\partial {q}_{k}} {\vert}_{2 δ t}$$

Evolve (un-clamped) for time δt.

$$q ( 3 δ t ) = \frac{{q}_{k}^{( 0 )}}{1 + ϵ} + \frac{{b ( δ t )}^{2}}{2 {m}_{k}} [ {a}^{2} ( 1 + ϵ ) - \frac{1 + a}{1 + ϵ} ] \frac{\partial {H}_{c}}{\partial {q}_{k}} {\vert}_{0} - \frac{{b ( δ t )}^{2}}{{m}_{k}} [ \frac{1}{1 + ϵ} - a ( 1 + ϵ ) ] \frac{\partial {H}_{c}}{\partial {q}_{k}} {\vert}_{δ t} + \frac{ϵ {b ( δ t )}^{2}}{2 {m}_{k}} \frac{\partial {H}_{uc}}{\partial {q}_{k}} {\vert}_{2 δ t} .$$

As can be seen from the above, with the appropriate choice of friction γ (which affects the α and b parameters) and ∈, update rules may be achieved.

FIG. 10 is high-level diagram illustrating an example two-chip architecture of a self-learning neuro-thermodynamic computer included in a dilution refrigerator and coupled to a classical computing device in an environment (which may be in the dilution refrigerator or external to the dilution refrigerator), according to some embodiments.

In some embodiments, a thermodynamic computing system 1000 (as shown in FIG. 10) may include a self-learning neuro-thermodynamic computing device 1002 placed in a dilution refrigerator 1008. The self-learning neuro-thermodynamic computing device 1002 comprises clamped chip 1004 and un-clamped chip 1006 arranged in a three-dimensional architecture (see also FIG. 11 described herein) of self-learning neuro-thermodynamic computing device 1002. In some embodiments, classical computing device 1012 may control temperature for dilution refrigerator 1008, and/or perform other tasks, such as helping to drive a pulse drive to change respective hyperparameters of the given system and/or perform measurements, such as shown in FIG. 4.

FIG. 11 illustrates an example hardware implementation of a given two-chip architecture of a self-learning neuro-thermodynamic computer, according to some embodiments.

In some embodiments, a two-chip architecture may resemble that which is shown in FIG. 11, wherein an un-clamped chip 1102 and a clamped chip 1104 are configured in a three-dimensional stacked architectural layout formation. A person having ordinary skill in the art should understand that hardware implementation 1100 resembles components of self-learning neuro-thermodynamic computing device 1002, which resides within dilution refrigerator 1008.

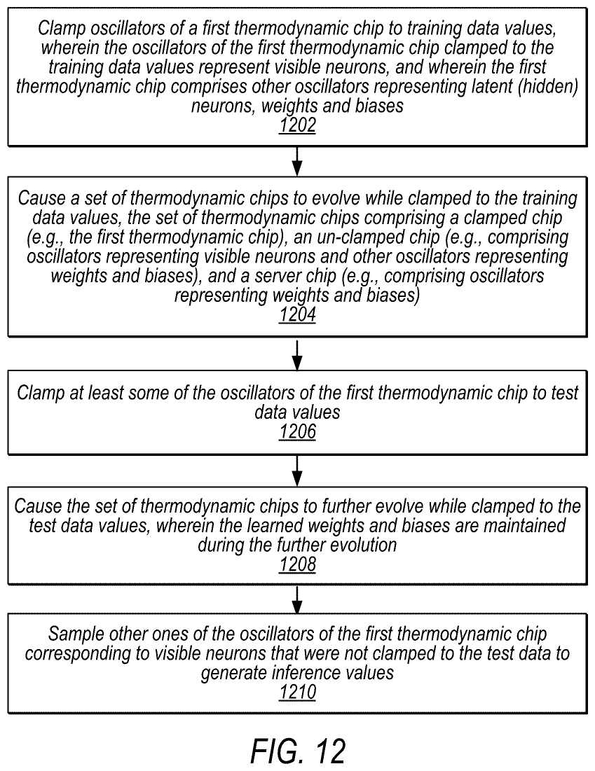

FIG. 12 illustrates a process of performing training and inference generation by applying an energy-based learning protocol to a three-chip architecture, according to some embodiments.

At block 1202, oscillators of a first thermodynamic chip (e.g. clamped chip 104) are clamped to training data values, wherein the oscillators of the first thermodynamic chip clamped to the training data values represent visible neurons, and wherein the first thermodynamic chip comprises other oscillators representing hidden neurons, weights and biases.

At block 1204, a set of thermodynamic chips (e.g. clamped chip 104, un-clamped chip 108, and server chip 106), such as are included in a self-learning neuro-thermodynamic computing device are allowed to evolve while clamped to the training data. This causes the weights and biases to be learned, as described above. In some embodiments, both clamped and un-clamped chips may have latent (hidden) neurons.

At bock 1206, at least some of the oscillators of the first thermodynamic chip (e.g. clamped chip 104) are clamped to test data values, while other ones of the oscillators corresponding to neurons for which values are to be inferred are left un-clamped.

At block 1208, the set of thermodynamic chips are allowed to further evolve such that the other ones of the oscillators corresponding to neurons for which values are to be inferred are left un-clamped take on values that can be measured to generate inference values.

At block 1210, the other ones of the oscillators are then sampled to generate the inference values.

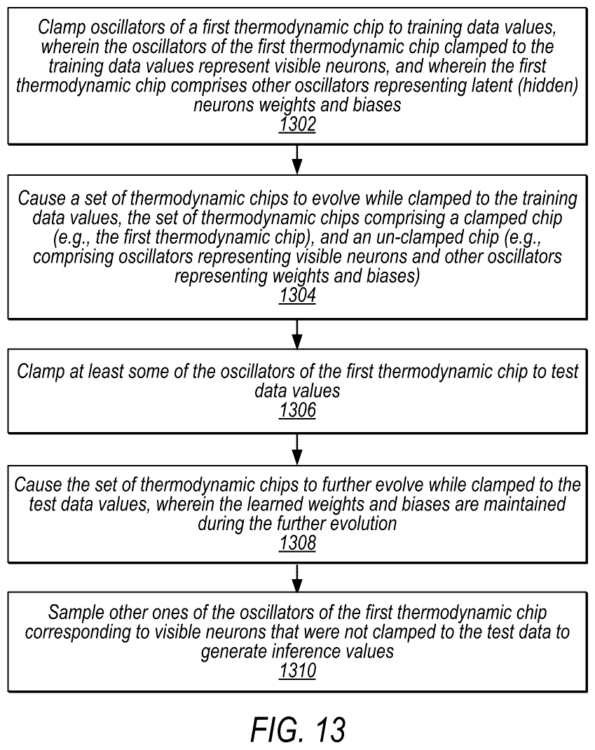

FIG. 13 illustrates a process of performing training and inference generation by applying an energy-based learning protocol to a two-chip architecture, according to some embodiments.

In some embodiments, a process described via blocks 1302-1310 may resemble that which is described herein with regard to blocks 1202-1210 but for a self-learning neuro-thermodynamic computing device 1002 containing direct coupling between a clamped chip and an un-clamped chip.

Embodiments of the present disclosure may be described in view of the following clauses:

Clause 1. A system, comprising:
a set of thermodynamic chips, each thermodynamic chip comprising:
   oscillators, wherein respective ones of the oscillators are coupled with one another in a configuration that corresponds to an engineered Hamiltonian;
wherein the set of thermodynamic chips comprises at least:
   a first thermodynamic chip comprising:
      oscillators representing a first set of visible neurons, at least some of which are clamped to input data;
      oscillators representing bias values for the first set of visible neurons; and
      oscillators representing weighting values for interactions between the first set of visible neurons;
   a second thermodynamic chip comprising:
      oscillators representing a second set of visible neurons, wherein the visible neurons of the second set are not clamped to the input data;
      oscillators representing bias values for the second set of visible neurons; and
      oscillators representing weighting values for interactions between the second set of visible neurons; and
   a server thermodynamic chip comprising:
      weighting value coordination oscillators and bias value coordination oscillators coupled, via position and momentum coupling, to the oscillators of the first and second thermodynamic chips representing the respective weighting values and bias values,
wherein the set of thermodynamic chips are configured to:
   learn values for the respective weighting values and bias values while the visible neurons of the first set are clamped, at least in part, to training data used as the input data, wherein evolution of the first and second thermodynamic chip coupled via the server thermodynamic chip learns the values for the respective weighting values and bias values;
   generate one or more inferences based on test data, wherein:
      at least some of the oscillators of the first thermodynamic chip corresponding to the visible neurons of the first set are clamped to the test data, while other oscillators of the first thermodynamic chip corresponding to visible neurons for which values are to be inferred are left un-clamped,
      the oscillators of the first and second thermodynamic chip coupled via the server thermodynamic chip evolve to generate inference values for visible neurons of the first thermodynamic chip that are to be inferred based on the test data; and
      the inference values are generated by sampling the visible neurons of the first thermodynamic chip corresponding to the inference values to be inferred based on the test data.

Clause 2. The system of clause 1, wherein positive and negative phase terms of the engineered Hamiltonian are used for the position and momentum couplings between the server thermodynamic chip and the first thermodynamic chip and between the server thermodynamic chip and the second thermodynamic chip,
wherein the positive and negative phase terms cause:
   the weighting values for the first and second thermodynamic chip to be same values within a threshold amount of difference, and
   the bias values for the first and second thermodynamic chip to be same values within a threshold amount of difference.

Clause 3. The system of clause 1 wherein the evolution of the oscillators of the first and second thermodynamic chip coupled via the server thermodynamic chip is an evolution according to Langevin dynamics.

Clause 4. The system of clause 1, wherein the first thermodynamic chip, the server thermodynamic chip and the second thermodynamic chip are arranged in a stacked configuration with the server thermodynamic chip positioned between the first thermodynamic chip and the second thermodynamic chip.

Clause 5. The system of clause 1, wherein the engineered Hamiltonian comprises a three-body coupling term that couples, for a respective one of the thermodynamic chips, the visible neurons, the weight values, and the bias values.

Clause 6. The system of clause 1, wherein:
the system further comprises a pulse drive; and
the pulse drive is configured to initialize respective hyperparameters of the engineered Hamiltonian.

Clause 7. The system of clause 1 wherein the oscillators are implemented using single-well or double-well protentional resonators.

Clause 8. The system of clause 1, wherein the inference values represent distributional values.

Clause 9. A method of performing training and inference generation using thermodynamic chips, the method comprising:
clamping oscillators of a first thermodynamic chip to training data values, wherein the oscillators of the first thermodynamic chip clamped to the training data values represent visible neurons, and wherein the first thermodynamic chip comprises other oscillators representing weights and biases;
causing a set of thermodynamic chips to evolve while clamped to the training data values, the set of thermodynamic chips comprising:
   the first thermodynamic chip with oscillators clamped to the training data values;
   a second thermodynamic chip comprising oscillators representing visible neurons that are not clamped to the training data values and other oscillators representing weights and biases; and
   a third thermodynamic chip that functions as a server thermodynamic chip and couples, via position and momentum coupling, oscillators of the first and second thermodynamic chips that represent complimentary weights and complimentary biases,
   wherein the evolution of the set of thermodynamic chips learns updated weights and biases that reflect relationships in the training data;
clamping at least some of the oscillators of the first thermodynamic chip to test data values;
causing the set of thermodynamic chips to further evolve while clamped to the test data values, wherein the learned weights and biases are maintained during the further evolution; and
sampling other ones of the oscillators of the first thermodynamic chip corresponding to visible neurons that were not clamped to the test data to generate inference values.

Clause 10. A system, comprising:
a set of thermodynamic chips, each thermodynamic chip comprising:
   oscillators, wherein respective ones of the oscillators are coupled with one another in a configuration that corresponds to an engineered Hamiltonian;
wherein the set of thermodynamic chips comprises at least:
   a first thermodynamic chip comprising:
      oscillators representing visible neurons for the first thermodynamic chip, at least some of which are clamped to input data, wherein the visible neurons for the first thermodynamic chip correspond to terms in a first engineered Hamiltonian for the first thermodynamic chip;
      oscillators representing bias values, in the first engineered Hamiltonian, for the visible neurons for the first thermodynamic chip; and
      oscillators representing weighting values, in the first engineered Hamiltonian, for interactions between the visible neurons of the first thermodynamic chip;
   a second thermodynamic chip comprising:
      oscillators representing visible neurons for the second thermodynamic chip, wherein the visible neurons for the second thermodynamic chip are not clamped to the input data, and wherein the visible neurons for the second thermodynamic chip correspond to terms in a second engineered Hamiltonian for the second thermodynamic chip;
      oscillators representing bias values, in the engineered Hamiltonian for the second thermodynamic chip, for the visible neurons for the second thermodynamic chip; and
      oscillators representing weighting values, in the engineered Hamiltonian for the second thermodynamic chip, for interactions between the visible neurons of the second thermodynamic chip; and
   a server thermodynamic chip comprising:
      weighting value coordination oscillators and bias value coordination oscillators coupled, via position and momentum coupling, to the oscillators of the first and second thermodynamic chips representing the respective weighting values and bias values in the respective first and second engineered Hamiltonians for the first and second thermodynamic chips.

Clause 11. A system, comprising:
a set of thermodynamic chips, each thermodynamic chip comprising:
oscillators, wherein respective ones of the oscillators are coupled with one another in a configuration that corresponds to an engineered Hamiltonian;
wherein the set of thermodynamic chips comprises at least:
   a first thermodynamic chip comprising:
      oscillators representing a first set of visible neurons, at least some of which are clamped to input data;
      oscillators representing bias values for the first set of visible neurons; and
      oscillators representing weighting values for interactions between the first set of visible neurons; and
   a second thermodynamic chip comprising:
      oscillators representing a second set of visible neurons, wherein the visible neurons of the second set are not clamped to the input data;
      oscillators representing bias values for the second set of visible neurons; and
      oscillators representing weighting values for interactions between the second set of visible neurons;
wherein the set of thermodynamic chips are configured to:
   learn values for the respective weighting values and bias values while the visible neurons of the first set are clamped, at least in part, to training data used as the input data, wherein evolution of the coupled first and second thermodynamic chip learns the values for the respective weighting values and bias values;
   generate one or more inferences based on test data, wherein:
      at least some of the oscillators of the first thermodynamic chip corresponding to the visible neurons of the first set are clamped to the test data, while other oscillators of the first thermodynamic chip corresponding to visible neurons for which values are to be inferred are left un-clamped,
      the coupled oscillators of the first and second thermodynamic chip evolve to generate inference values for visible neurons of the first thermodynamic chip that are to be inferred based on the test data; and
      the inference values are generated by sampling the visible neurons of the first thermodynamic chip corresponding to the inference values to be inferred based on the test data.

Clause 12. The system of clause 11, wherein positive and negative phase terms of the engineered Hamiltonian are used for position and momentum couplings between the first thermodynamic chip and the second thermodynamic chip,
wherein the positive and negative phase terms cause:
   the weighting values for the first and second thermodynamic chip to be same values within a threshold amount of difference, and
   the bias values for the first and second thermodynamic chip to be same values within a threshold amount of difference.

Clause 13. The system of clause 11 wherein the evolution of the coupled oscillators of the first and second thermodynamic chip is an evolution according to Langevin dynamics.

Clause 14. The system of clause 11, wherein the first thermodynamic chip and the second thermodynamic chip are arranged in a stacked configuration.

Clause 15. The system of clause 11, wherein the engineered Hamiltonian comprises a three-body coupling term that couples, for a respective one of the thermodynamic chips, the visible neurons, the weight values, and the bias values.

Clause 16. The system of clause 11, wherein:
the system further comprises a pulse drive; and
the pulse drive is configured to initialize respective hyperparameters of the engineered Hamiltonian.

Clause 17. The system of clause 11 wherein the oscillators are implemented using single-well or double-well protentional resonators.

Clause 18. The system of clause 11, wherein the inference values represent distributional values.

Clause 19. A method of performing training and inference generation using thermodynamic chips, the method comprising:
clamping oscillators of a first thermodynamic chip to training data values, wherein the oscillators of the first thermodynamic chip clamped to the training data values represent visible neurons, and wherein the first thermodynamic chip comprises other oscillators representing weights and biases;
causing a set of thermodynamic chips to evolve while clamped to the training data values, the set of thermodynamic chips comprising:
   the first thermodynamic chip with oscillators clamped to the training data values; and
   a second thermodynamic chip comprising oscillators representing visible neurons that are not clamped to the training data values and other oscillators representing weights and biases; and
   wherein the evolution of the set of thermodynamic chips learns updated weights and biases that reflect relationships in the training data;
clamping at least some of the oscillators of the first thermodynamic chip to test data values;
causing the set of thermodynamic chips to further evolve while clamped to the test data values, wherein the learned weights and biases are maintained during the further evolution; and
sampling other ones of the oscillators of the first thermodynamic chip corresponding to visible neurons that were not clamped to the test data to generate inference values.

### Illustrative Computer System

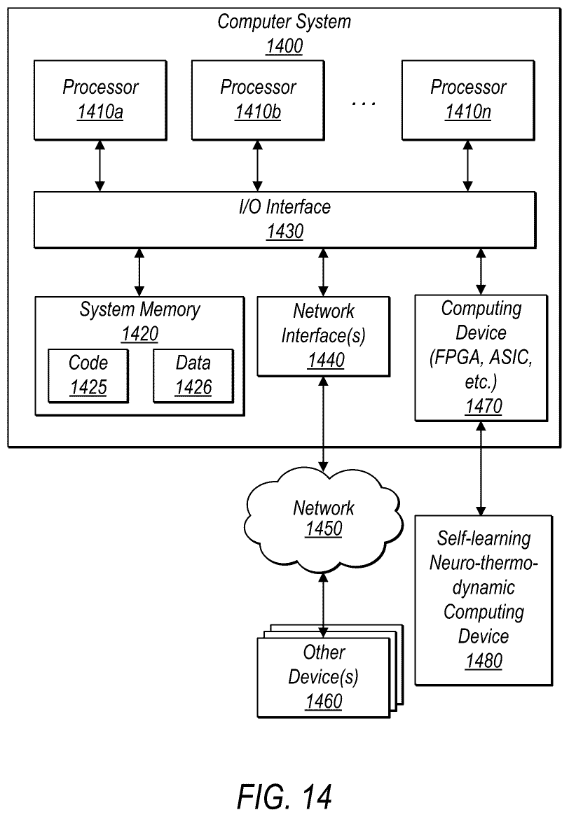

FIG. 14 is a block diagram illustrating an example computer system that may be used in at least some embodiments. In some embodiments, the computing system shown in FIG. 14 may be used, at least in part, to implement any of the techniques described above in FIGS. 1-13. For example, program instructions that implement protocols, techniques, etc. may be stored in a non-transitory computer readable medium and/or may be executed by one or more processors, such as the processors of computer system 1400. Furthermore, computer system 1400 may be configured to interact and/or interface with self-learning neuro-thermodynamic computing device 1480, according to some embodiments.

In the illustrated embodiment, computer system 1400 includes one or more processors 1410 coupled to a system memory 1420 (which may comprise both non-volatile and volatile memory modules) via an input/output (I/O) interface 1430. Computer system 1400 further includes a network interface 1440 coupled to I/O interface 1430. Classical computing functions may be performed on a classical computer system, such as computing computer system 1400.

Additionally, computer system 1400 includes computing device 1470 coupled to thermodynamic chip 1480. In some embodiments, computing device 1470 may be a field programmable gate array (FPGA), application specific integrated circuit (ASIC) or other suitable processing unit. In some embodiments, computing device 1470 may be a similar computing device as described in FIGS. 1-13, such as classical computing devices 114 and 1012. In some embodiments, self-learning neuro thermodynamic computing device 1480 may be a similar self-learning neuro thermodynamic computing device as described in FIGS. 1-13, such as self-learning neuro thermodynamic computing device 102, thermodynamic chip 202/252, and self-learning neuro thermodynamic computing device 1002.

In various embodiments, computer system 1400 may be a uniprocessor system including one processor 1410, or a multiprocessor system including several processors 1410 (e.g., two, four, eight, or another suitable number). Processors 1410 may be any suitable processors capable of executing instructions. For example, in various embodiments, processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA. In some implementations, graphics processing units (GPUs) may be used instead of, or in addition to, conventional processors.

System memory 1420 may be configured to store instructions and data accessible by processor(s) 1410. In at least some embodiments, the system memory 1420 may comprise both volatile and non-volatile portions; in other embodiments, only volatile memory may be used. In various embodiments, the volatile portion of system memory 1420 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1420 as code 1425 and data 1426.

In some embodiments, I/O interface 1430 may be configured to coordinate I/O traffic between processor 1410, system memory 1420, computing device 1470, and any peripheral devices in the computer system, including network interface 1440 or other peripheral interfaces such as various types of persistent and/or volatile storage devices. In some embodiments, I/O interface 1430 may perform any necessary protocol, timing or other data transformations to convert data signals from one component (e.g., system memory 1420) into a format suitable for use by another component (e.g., processor 1410).

In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computing device 1400 and other devices 1460 attached to a network or networks 1450, such as other computer systems or devices. In various embodiments, network interface 1440 may support communication via any suitable wired or wireless general data networks, such as types of Ethernet network, for example. Additionally, network interface 1440 may support communication via telecommunications/telephony networks such as analog voice networks or digital fiber communications networks, via storage area networks such as Fibre Channel SANs, or via any other suitable type of network and/or protocol.

In some embodiments, system memory 1420 may represent one embodiment of a computer-accessible medium configured to store at least a subset of program instructions and data used for implementing the methods and apparatus discussed in the context of FIG. 1 through FIG. 13. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1400 via I/O interface 1430. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1400 as system memory 1420 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1440. Portions or all of multiple computing devices such as that illustrated in FIG. 14 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system, comprising:
a set of thermodynamic chips, each thermodynamic chip comprising:
oscillators, wherein respective ones of the oscillators are coupled with one another in a configuration that corresponds to an engineered Hamiltonian;
wherein the set of thermodynamic chips comprises at least:
a first thermodynamic chip comprising:
oscillators representing a first set of visible neurons, at least some of which are clamped to input data;
oscillators representing bias values for the first set of visible neurons; and
oscillators representing weighting values for interactions between the first set of visible neurons;
a second thermodynamic chip comprising:
oscillators representing a second set of visible neurons, wherein the visible neurons of the second set are not clamped to the input data;
oscillators representing bias values for the second set of visible neurons; and
oscillators representing weighting values for interactions between the second set of visible neurons; and
a server thermodynamic chip comprising:
weighting value coordination oscillators and bias value coordination oscillators coupled, via position and momentum coupling, to the oscillators of the first and second thermodynamic chips representing the respective weighting values and bias values,
wherein the set of thermodynamic chips are configured to:
learn values for the respective weighting values and bias values while the visible neurons of the first set are clamped, at least in part, to training data used as the input data, wherein evolution of the first and second thermodynamic chip coupled via the server thermodynamic chip learns the values for the respective weighting values and bias values;
generate one or more inferences based on test data, wherein:
at least some of the oscillators of the first thermodynamic chip corresponding to the visible neurons of the first set are clamped to the test data, while other oscillators of the first thermodynamic chip corresponding to visible neurons for which values are to be inferred are left un-clamped,
the oscillators of the first and second thermodynamic chip coupled via the server thermodynamic chip evolve to generate inference values for visible neurons of the first thermodynamic chip that are to be inferred based on the test data; and
the inference values are generated by sampling the visible neurons of the first thermodynamic chip corresponding to the inference values to be inferred based on the test data.

2. The system of claim 1, wherein positive and negative phase terms of the engineered Hamiltonian are used for the position and momentum couplings between the server thermodynamic chip and the first thermodynamic chip and between the server thermodynamic chip and the second thermodynamic chip,
wherein the positive and negative phase terms cause:
the weighting values for the first and second thermodynamic chip to be same values within a threshold amount of difference, and
the bias values for the first and second thermodynamic chip to be same values within a threshold amount of difference.

3. The system of claim 1 wherein the evolution of the oscillators of the first and second thermodynamic chip coupled via the server thermodynamic chip is an evolution according to Langevin dynamics.

4. The system of claim 1, wherein the first thermodynamic chip, the server thermodynamic chip and the second thermodynamic chip are arranged in a stacked configuration with the server thermodynamic chip positioned between the first thermodynamic chip and the second thermodynamic chip.

5. The system of claim 1, wherein the engineered Hamiltonian comprises a three-body coupling term that couples, for a respective one of the thermodynamic chips, the visible neurons, the weight values, and the bias values.

6. The system of claim 1, wherein:
the system further comprises a pulse drive; and
the pulse drive is configured to initialize respective hyperparameters of the engineered Hamiltonian.

7. The system of claim 1 wherein the oscillators are implemented using single-well or double-well protentional resonators.

8. The system of claim 1, wherein the inference values represent distributional values.

9. A method of performing training and inference generation using thermodynamic chips, the method comprising:
clamping oscillators of a first thermodynamic chip to training data values, wherein the oscillators of the first thermodynamic chip clamped to the training data values represent visible neurons, and wherein the first thermodynamic chip comprises other oscillators representing weights and biases;
causing a set of thermodynamic chips to evolve while clamped to the training data values, the set of thermodynamic chips comprising:
the first thermodynamic chip with oscillators clamped to the training data values;
a second thermodynamic chip comprising oscillators representing visible neurons that are not clamped to the training data values and other oscillators representing weights and biases; and
a third thermodynamic chip that functions as a server thermodynamic chip and couples, via position and momentum coupling, oscillators of the first and second thermodynamic chips that represent complimentary weights and complimentary biases,
wherein the evolution of the set of thermodynamic chips learns updated weights and biases that reflect relationships in the training data;
clamping at least some of the oscillators of the first thermodynamic chip to test data values;
causing the set of thermodynamic chips to further evolve while clamped to the test data values, wherein the learned weights and biases are maintained during the further evolution; and
sampling other ones of the oscillators of the first thermodynamic chip corresponding to visible neurons that were not clamped to the test data to generate inference values.

10. The method of claim 9, wherein respective ones of the oscillators of the first, second, and third thermodynamic chips are coupled with one another in a configuration that corresponds to an engineered Hamiltonian.

11. The method of claim 10, wherein positive and negative phase terms of the engineered Hamiltonian are used for the position and momentum couplings between the server thermodynamic chip and the first thermodynamic chip and between the server thermodynamic chip and the second thermodynamic chip.

12. The method of claim 11, wherein the positive and negative phase terms cause:
the weighting values for the first and second thermodynamic chip to be same values within a threshold amount of difference, and
the bias values for the first and second thermodynamic chip to be same values within a threshold amount of difference.

13. The method of claim 9, wherein the evolution of the oscillators of the first and second thermodynamic chip coupled via the server thermodynamic chip is an evolution according to Langevin dynamics.

14. The method of claim 9, wherein the first thermodynamic chip, the server thermodynamic chip, and the second thermodynamic chip are arranged in a stacked configuration with the server thermodynamic chip positioned between the first thermodynamic chip and the second thermodynamic chip.

15. The method of claim 9, wherein the thermodynamic chips used in performing the training and inference generation, further comprise:
one or more additional thermodynamic chips comprising oscillators representing visible neurons that are clamped to training data values; or
another set of one or more additional thermodynamic chips comprising oscillators representing visible neurons that are not clamped to the training data values,
wherein the server thermodynamic chip couples, via position or momentum coupling, oscillators of the one or more additional thermodynamic chips or oscillators of the other set of additional thermodynamic chips to oscillators of the first or second thermodynamic chips.

16. The method of claim 9, wherein the engineered Hamiltonian comprises a three-body coupling term that couples, for a respective one of the thermodynamic chips, the visible neurons, the weight values, and the bias values.

17. The method of claim 9, wherein the oscillators are implemented using single-well protentional resonators.

18. The method of claim 9, wherein the oscillators are implemented using double-well protentional resonators.

19. A system, comprising:
a set of thermodynamic chips, each thermodynamic chip comprising:
oscillators, wherein respective ones of the oscillators are coupled with one another in a configuration that corresponds to an engineered Hamiltonian;
wherein the set of thermodynamic chips comprises at least:
a first thermodynamic chip comprising:
oscillators representing visible neurons for the first thermodynamic chip, at least some of which are clamped to input data;
oscillators representing bias values, in the engineered Hamiltonian, for the visible neurons for the first thermodynamic chip; and
oscillators representing weighting values for interactions between the visible neurons of the first thermodynamic chip;
a second thermodynamic chip comprising:
oscillators representing visible neurons for the second thermodynamic chip, wherein the visible neurons for the second thermodynamic chip are not clamped to the input data;
oscillators representing bias values for the visible neurons for the second thermodynamic chip; and
oscillators representing weighting values for interactions between the visible neurons of the second thermodynamic chip; and
a server thermodynamic chip comprising:
weighting value coordination oscillators and bias value coordination oscillators coupled, via position and momentum coupling, to the oscillators of the first and second thermodynamic chips representing the respective weighting values and bias values.

20. The system of claim 19, wherein positive and negative phase terms of an overall engineered Hamiltonian are used for the position and momentum couplings between the server thermodynamic chip and the first thermodynamic chip and between the server thermodynamic chip and the second thermodynamic chip,
wherein the positive and negative phase terms cause:
the weighting values for the first and second thermodynamic chip to be same values within a threshold amount of difference, and
the bias values for the first and second thermodynamic chip to be same values within a threshold amount of difference.
